(19) United States
(12) Patent Application Publication
(10) Pub. No.: US 2018/0204467 A1
(43) Pub. Date: Jul. 19, 2018

(54) EPHEMERAL FLIGHTS WITH TRANSIENT WINDOWS

(71) Applicant: AirProxima, Inc., Ketchum, ID (US)

(72) Inventors: Edward Crump, Santa Cruz, CA (US); Daniel Bay, Ketchum, ID (US); David Madaras, Ketchum, ID (US); Haley Hebert, San Francisco, CA (US)

(21) Appl. No.: 15/622,055

(22) Filed: Jun. 13, 2017

Related U.S. Application Data
(60) Provisional application No. 62/447,392, filed on Jan. 17, 2017.

(51) Int. Cl. G08G 5/00; G06Q 30/02

(52) U.S. Cl. CPC G08G 5/0034; G06Q 30/0205; G06Q 30/0206; G06Q 10/025; G06Q 30/0283; G06Q 30/0223; G08G 5/0039

(57) ABSTRACT

This disclosure describes techniques for analyzing flights and identifying opportunities to provide flights to passengers that might not otherwise be made available. Benefits of these systems and methods may include filling more seats in aircraft that would otherwise go unfilled providing more flight opportunities to passengers as well as increasing opportunities to sell more flights for operators of the aircraft. For example, a charter operator might increase revenue through marketing automation and increased marketing reach they could otherwise not access themselves. Additionally, the system may provide tools for marketing and monetizing an operator's unused aircraft capacity. Additionally, the system may provide tools to move aircraft to areas where a demand will be, for example, by generating and selling flights that move the aircraft in that direction over the time leading up to the demand.

### RELATED APPLICATION

This Application claims the benefit of U.S. Provisional Patent Application No. 62/447,392 entitled “Operator Aero Ephemeral Flights,” filed on Jan. 17, 2017, which is incorporated herein by reference.

### BACKGROUND

For most passengers, air travel usually takes the form of reserving seats on large commercial aircraft. The larger airline operators typically route their aircraft according to a well-known hub and spoke pattern where aircraft fly from points to a hub and then back out to points. For example, to fly from Spokane, Wash., to Austin, Tex. on Alaska Airlines, the passenger usually books a route that includes a first leg from Spokane to Seattle a second leg from Seattle to Austin. The return flight is just the opposite, with a first leg from Austin to Seattle, and a second leg from Seattle to Spokane. In this scenario, Seattle functions as the hub for Alaska Airlines with the spokes being the legs to Spokane and Austin. Due to this hub-and-spoke arrangement and the larger number of passengers, this is the most affordable way to travel by air.

For people that live more remotely, and not near larger cities with airports, this commercial way to travel is more difficult. For instance, if a passenger wanted to travel from Santa Cruz, Calif. to Sun Valley, Id., the commercial trip would involve driving to a commercial airport like San Jose or San Francisco, following a hub-and-spoke pattern to Boise, Id., and then finding other transportation (such as a local private plane or automobile to Sun Valley). Private or chartered air travel has evolved to allow a more point-to-point solution so that the passenger could fly directly from a smaller airport near Santa Cruz to an airport near Sun Valley. Unfortunately, private or chartered air travel is significantly more expensive than commercial air travel. This expense is due in part to the fact that carriers cannot leverage larger numbers of passengers and the cost-effective hub-and-spoke arrangement for mass travel, making each individual flight costlier. As a result of this cost, many of the smaller aircraft that are privately owned or used in charters remain on the ground for much of the time and often sit idle 90% of the time. And even when the aircraft is used, there is often significant unused flight segments as part of the overall operation. In our example, for instance, the aircraft may return from Sun Valley to Santa Cruz without the passenger. Later, the aircraft may have to return to Sun Valley in an unused segment to pick up and return the passenger to Santa Cruz. This cost is added to the full charter service, contributing to the higher cost. There is much waste in the private and chartered ecosystem, keeping costs high. Unfortunately, potential travelers are not well versed in private air travel and the reasons for these economics and hence rarely pursue the option of private or charted aircraft due the high costs.

Accordingly, there is a need for a way to reduce the costs of private air travel, increase the efficiency for operators, and expose private air travel in a more compelling light for potential air travelers.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

This disclosure describes techniques for analyzing flights and identifying opportunities to provide flights to passengers that might not otherwise be made available. Benefits of these systems and methods may include filling more seats in aircraft that would otherwise go unfilled providing more flight opportunities to passengers as well as increasing opportunities to sell more flights for operators of the aircraft. For example, a charter operator might increase revenue through marketing automation and increased marketing reach they could otherwise not access themselves. Additionally, the system may provide tools for marketing and monetizing an operator's unused aircraft capacity. Additionally, the system may provide tools to move aircraft to areas where a demand will be, for example, by generating and selling flights that move the aircraft in that direction over the time leading up to the demand

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items.

FIG. 1 is a view of an illustrative geographical operating environment for operating aircraft for multiple locations, with illustrative flight segments between locations.

FIGS. 2-5 are views of illustrative timelines of possible flights available in the geographical operating environment of FIG. 1.

FIGS. 6-8 are schematic diagrams of illustrative environments and flows of information in systems that may generate and leverage information shown in FIGS. 1-5.

FIG. 9 is an illustrative flowchart showing illustrative steps and considerations to create and post flight information.

FIG. 10 shows an illustrative computing system that implements the disclosed systems.

FIGS. 11 and 12 show illustrative operating systems and environments.

FIG. 13 is a view of an illustrative geographical operating environment for operating aircraft for multiple locations, with illustrative flight segments between locations.

FIG. 14 is a view of an illustrative geographical operating environment for operating aircraft for multiple locations.

FIG. 15 is an illustrative flowchart showing illustrative steps and considerations to book and coordinate a flight.

FIGS. 16-58 show illustrative user interfaces allowing a user to create flights, select flights, and price flights.

### DETAILED DESCRIPTION

Overview

This disclosure describes techniques for analyzing flights and identifying opportunities to provide flights to passengers that might not otherwise be made available. Benefits of these techniques may include filling more seats in aircraft that would otherwise go unfilled, providing more flight opportunities to passengers, and increasing opportunities to sell more flights for operators of the aircraft. Additionally, the techniques may provide tools for marketing and monetizing an operator's unused aircraft capacity.

The techniques are implemented by various computing systems, computer-implemented processes, and user interfaces that are directed to and designed for FAR part 135 charter operators to reach more of their desired customers, simplify their marketing activities, and sell more flights. Additionally or alternatively, operators operating under FAR parts 121, 125, or 91K, as well as cargo operators may implement the disclosed techniques. The system may comprise a cloud-based service that helps the charter operator reach more desired customers by marketing flights to the public online via social media and networks (Facebook™, Twitter™, Google+™, LinkedIn™); online flight search tools (online travel agents—OTAs) such as Kayak™, Hipmunk™, and Google Flights™; and through digital marketing of the system's flight portal.

An operator may input flight segments they would like to market, such as repositioning flights, upcoming empty legs, or simply new charter legs. The system may increase the likelihood of selling a given segment by using real time demand prediction and inventory of flight segments to generate a large selection of possible ephemeral flight options (EFOs). Additionally, the system may identify a location where demand is predicted at an upcoming time. Here the system may generate flights that move the aircraft towards the location of the predicted demand prior to the time of the demand, as for example, a proactive flight scheduling approach. The system may predict demand based at least in part on scheduled events based databases, weather predictions, news, among other sources of information. Additionally or alternatively, the system may, based on an indication of an operator that the aircraft will be located at a given location for a given window of time, generate ephemeral flights from that location, or nearby locations, returning the aircraft to that location before the end of the window. The operator may select which of the EFOs to market directly to the public.

Various embodiments contemplate techniques for inputting flight segments. For example, an operator may input two airports, an origin and a destination, and a flight window which is the earliest departure the operator is willing to make from the origin combined with the latest time the operator wishes the aircraft to arrive at its destination. Various embodiments contemplate that the system may have a default, where the operator has a customizable home base identified for each aircraft, and which may be used when computing the direct operating costs to reposition the aircraft to the origin, the cost of the customer flight itself, and the cost of the repositioning flight from the destination back to home base. When creating a segment, the operator may set a “minimum acceptable price” for the customer flight itself. Various embodiments contemplate that the minimum acceptable price may take into account the total direct operating costs for that flight (for example, the aircraft's hourly rate multiplied by the total travel time, including repositioning legs). Additionally or alternatively, various embodiments contemplate that the minimum acceptable price may not be tied to direct operating costs at all. For example, an operator may have already sold multiple segments, where the original purchaser will only occupy a subset of the multiple segments, or the operator may be flying to the location for other reasons (for example, personal reasons, including, but not limited to, vacations, appointments, meetings, among others. In this example, the operator may set the minimum acceptable price much lower than the direct operating costs, since the operating costs are already committed. However, the operator may adjust the minimum acceptable price up or down as desired. Additionally or alternatively, the operator may reduce prices based on competition with other operators or other means of transportation.

Various embodiments contemplate taking operator defined constraints, crossing those against a demand prediction, showing the operator a series of flight options which may be optimized by route and time to have a high probability of selling, and allows the operator to publish these ephemeral flights, for example, with a single click. The operator may configure automatic filtering of these flight options to avoid flights that are too short or too long, flights involving airports the operator does not wish to service, flights that involve weather or time-of-day conditions the operator wishes to avoid, and flights that compromise crew constraints or crew duty hour constraints, for example, flights that exceed a maximum daily flight time limit. Various embodiments contemplate that the system may have a flight publishing engine. Various embodiments cause the flight publishing engine to adhere to rules governing the publishing of flights (for example, FAR part 110 definition of “on-demand charter”) so the operator doesn't have to manage this complexity.

Various embodiments provide automatic prices of EFOs based on the minimum acceptable price the operator inputted on the original flight segment. The system may automatically determine a price for each EFO based on that minimum acceptable price plus any additional cost incurred for additional flight time, additional segments, or airport fees incurred in serving that option. The operator may either accept these prices or override them with a desired price. Various embodiments contemplate that the operator will always receive the exact amount shown for serving that route, and will always have final say on all flight bookings before they are confirmed.

Additionally or alternatively, any ephemeral flight option that the operator does not want to serve for any reason may be removed and not be marketed. When the operator is satisfied with the prices and routes of the EFOs, the operator may submit the flights. The system may then distribute the submitted EFOs to the public across various marketing channels. When a customer requests a flight booking, the operator may receive a notification and may confirm the flight via a mobile device, computer, or contact the customer directly to discuss their trip details before confirming the flight. Upon the flight booking confirmation, all ephemeral flight options that conflict with that flight booking may be automatically pulled from all marketing channels.

Illustrative Operating Environment and Flights

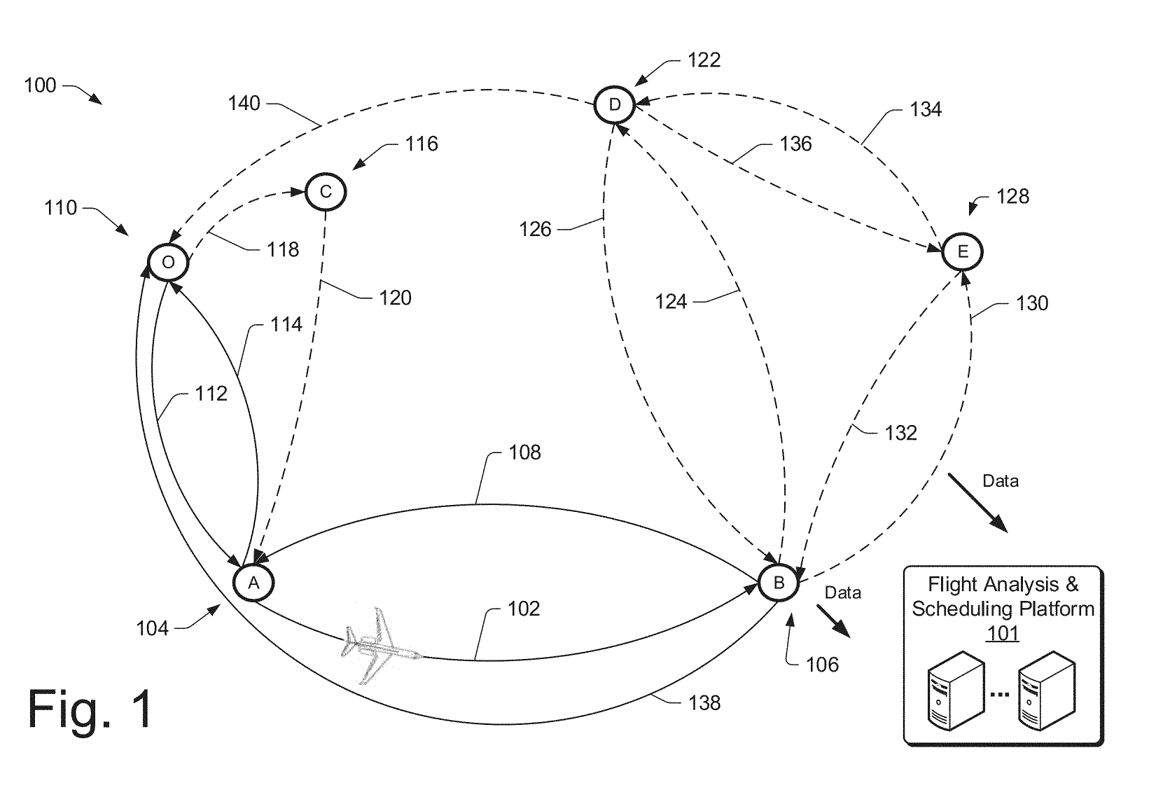

FIG. 1 shows an illustrative operating environment 100 with several illustrative locations. In this illustrative example, an operator has agreed to fly a chartered flight 102 from location A 104 or location B 106 with a return flight 108. Prior to flight 102, the operator has his aircraft originate from location O 110. Under normal circumstances prior to the innovative aspects discussed as part of this disclosure, if, for example, the operator is based out of location O, then the operator will expect to have an empty leg flight 112 from location O 110 to location A 104 prior to flight 102 to get the aircraft to location A 104 in anticipation of flight 102. Similarly, upon completion of the return flight 108 to location A 104, the operator may expect to have an empty leg flight 114 to return to location O, 110. However, the systems and methods discussed herein, may allow for existing or expected empty leg flights, and/or additional flights to be populated with passengers. For example, illustrative embodiments of the present system may identify flights 112 and 114 as candidates for an ephemeral flight option (EFO). Based at least in part on the departure time of flight 102 and the availability of the operator to fly from location O 110, a window of flight time or an available flight window (AFW) may be identified. As will be discussed later in this disclosure, one or more flights originating and landing within the AFW may be identified and may be populated with passengers. Additionally, or alternatively, an AFW for flight 114 may be identified based at least in part on the scheduled landing of flight 108 and a desired time of arrival at location O 110 by the operator. Various embodiments contemplate that an AFW may have a wide range. For example, the operator may desire or be required to have a short window prior to flight 102 causing a relatively short AFW. Alternatively, the operator may be willing to arrive at location A 104 well ahead of flight 102, for example, from several hours to several days, or more. This variability of AFWs may lead to a similar variability of identified EFOs.

Additionally or alternatively, additional EFOs may be identified. For example, illustrative embodiments may identify location C 116 as possible location for an EFO. Based at least in part of the AFW discussed above, the system may note a demand, a request, or otherwise identify a potential for a flight 118 to location C from location O or for a flight 120 from location C to location A. As discussed elsewhere in this disclosure, potential flights 118 and 120 may be extrapolated to identify EFOs. Similarly, based at least in part on the AFW after flight 108, additional potential flights (without arrows) may be identified from location A to location C and/or from location C to location O.

Additionally or alternatively, an AFW may exist between flights 102 and 108. As such, there may be an AFW where the aircraft originates from location B at the beginning of the AFW and needs to return to location B no later than the end of the AFW. Various embodiments contemplate that the system may identify additional EFOs based on this AFW. For example, location D 122 may be within a certain geographic range of location B. Based at least in part on the AFW, the system may identify flight 124 from location B to location D as a possibility to create EFOs. Similarly, the system may identify flight 126 from location D to location B as a possibility to create EFOs. Additionally or alternatively, location E 128 may be within a certain geographic range of location B and may or may not be within a certain geographic range of location D. As discussed with respect to location D, the system may identify flight 130 from location B to location E and flight 132 from location E to location B as possibilities to create EFOs. Additionally or alternatively, based at least in part on the AFW and the geographic range between locations B, D, and E, the system may identify flight 134 from location E to location D and flight 136 from location D to location E as possibilities to create EFOs.

Additionally or alternatively, the system may combine various legs to identify additional effective flights. For example, the system may identify a flight from location B to location D with a stop at location E. This example, would look to the combination of flights 130 and 134 as a possibility to create EFOs. This example may also be combined with flight 126 from location D to location B or flights 136 and 132 from location D to location B with a stop at location E. This approach may be expanded to other combinations of the identified locations as well as other locations (not shown). These combinations may provide additional flight options to further leverage the AFW where a demand or opportunity exists to fly to multiple cities within the AFW where different passengers desire to move between different cities. Additionally or alternatively, multiple operators providing different flight legs may be combined to generate an effective “round trip” for a user.

Additionally or alternatively, various embodiments contemplate that the return flight 108 of the chartered flight 102 is either canceled or not booked in the first place. In this example, since the operator is expected to return the plane to location O, the system may identify flight 138 from location B to location O as a possibility to create EFOs based on the AFW, since flight 138 might otherwise be an empty leg flight. Additionally or alternatively, the system may identify flight 108 from location B to location A as a possibility to create EFOs as well as flight 114 from location A to location O. Additionally or alternatively, the system may identify flight 140 from location D to location O as a possibility to create EFOs. Additionally or alternatively, the system may predict a future demand at a future time at a future location. In this example, the system may generate ephemeral flights that move on or more aircraft in the direction of the future location prior to the future time, to be in a position to meet the predicted future demand.

While the discussion identifies locations A, B, C, D, E, and O with identified arrows connecting some of the locations, they are merely limited illustrative examples. Rather, this disclosure is intended to show a large number of available permutations that the system may identify to create EFOs from. For example, based on the AFW, the system may identify a flight from location D to location C to location O to create EFOs based upon. Additionally or alternatively, based on the AFW, the system may identify location B to location E to location D to location B to location E to location D to location B as a possibility to create EFOs from. (In this example, there may be a demand for multiple repeating flights during the AFW that the system may identify and the operator may fulfill. For example, the operator may fly turns between several locations during the AFW.)

Illustrative Available Flight Windows and Ephemeral Flight Options

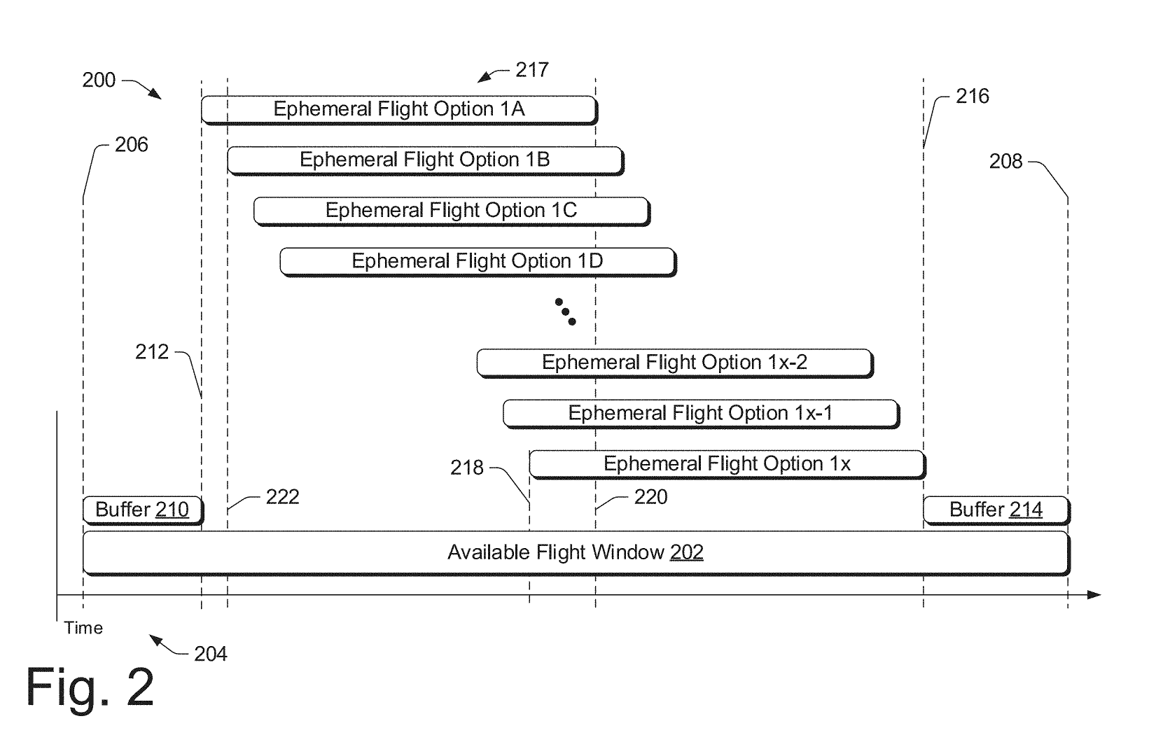

FIG. 2 shows a depiction 200 of an illustrative available flight window (AFW) with illustrative ephemeral flight options (EFO). For example, FIG. 2 shows an AFW 202, on a timeline 204 where the AFW 202 has a beginning time 206 and an ending time 208. This AFW 202 represents the window of time the aircraft may be available for additional flights. AFW 202 may include a buffer 210 of time beginning at time 206 and ending at time 212. Additionally or alternatively, the system may include a buffer 214 that begins at time 216 and ends at time 208. The system may institute buffer 210 and/or buffer 214 based on various considerations. For example, buffers 210 and 214 may provide time for events that are triggered by additional flights within the AFW including but not limited to additional refueling, additional pilot rest, additional aircraft maintenance, additional aircraft preparation or reconfiguration, predicted delays for weather or congested airports, operators preferences, crew duty hours, crew swaps, aircraft cleaning, aircraft configuration conversions (e.g., adding or removing seats and/or adding or removing cargo), available airport landing slots (ATC), unexpected flight reroutings, among others. Additionally or alternatively, the beginning and ending times 206 and 208 of AFW 202 may take into account expected buffer times for any predetermined flights, including for example, preparing the aircraft for the original chartered flight.

The system may use AFW 202 to begin generating possible ephemeral flight options (EFOs). For example, the system may consider geographic distances, geographic locations, airport configurations, anticipated weather, anticipated head or tail winds, airport congestion, as well as operator preferences, predicted consumer demand that may be found at an airport, flight delays or disruptions to commercial service, events such as sports, concerts, conventions, rallies that may affect demand predictions, among others to generate possible EFOs. For example, as discussed with respect to FIG. 1, AFW 202 may correspond to an AFW between the operators departure from location O on flight 112 to location A. In this example, flight 112 is expected to arrive at location A prior to time 208 with a flight duration 217. Additionally or alternatively, the operator may identify time 206 as the earliest he is willing to depart location O.

One option is to offer flight 112 with a departure window. For example, flight 112 is available to leave between times 206 and 218 arriving at location A no later than time 208 (or 216). Another option is to offer flight 112 with an arrival window of time between time 220 and time 208 (or 216) leaving no earlier than time 206. However, current flight scheduling systems and associated market places are not configured to handle flights based on departure or arrival windows very well, if at all. As such, it may be beneficial to provide discrete flight options that reflect the flight windows.

With the AFW 202 and associated flight information, preferences, etc, the system may generate any number of possible ephemeral flight options originating from location O and arriving at location A. For example, the system may generate EFO 1A, EFO 1B, . . . EFO 1x as shown in FIG. 2 where x may be any number, where various embodiments contemplate a discrete number, where other embodiments contemplate a theoretical infinite number. In this example, each EFO may have a different departure time and arrival time. For example, EFO 1A may depart at time 220 where EFO 1x may depart at time 218 and arrive at time 216. Various embodiments contemplate that the number of EFOs x may be based on several factors. For example, the number of EFO flights x may be based on the AFW 202 and a desired separation of departure or arrival times. For example, EFO 1A may depart at time 212 while EFO 1B may depart at time 222. The difference between time 212 and 222 may be fixed or within a range. For example, time difference may be between one minute and five minutes, one minute and 15 minutes, five minutes and 15 minutes, 15 minutes and 30 minutes, 30 minutes and 45 minutes, 30 minutes and 60 minutes, 60 minutes and 120 minutes, one hour and four hours, two hours and six hours, or combinations thereof. Various factors may be taken into account that may drive the time ranges beyond the discussed ranges. For example, in remote locations, potential passengers may be more flexible with departure or arrival times allowing for fewer EPOs to be generated by the system for a given AFW when compared to a more populated location where potential passengers may desire more granularity in departure or arrival times. Additionally or alternatively, other industries using this system, including, but not limited to, cargo, shipping, unmanned or autonomous vehicles, including unmanned air vehicles, may desire even more granularity on the order of seconds. Additionally or alternatively, various embodiments contemplate that the routes need not be flights, but may be fulfilled by other forms of transportation including, but not limited to, boats, ships, automobiles, bicycles, trains, aircraft including airplanes and helicopters, among others. Additionally or alternatively, any vehicle may be powered by different sources or combinations thereof, including, for example, internal combustion vehicles, electric vehicles, hybrid vehicles, nuclear powered vehicles, solar powered vehicles, among others.

Additionally or alternatively, the separation of EFO departure or arrival times may be clustered more tightly together at certain times of the day or certain events. For example, if the AFW 202 includes a portion of traditional business commuting times, more EFOs may be generated across those traditional commuting times when compared to other portions of the AFW 202. Additionally or alternatively, more EFOs may be generated after an event is expected to end, for example a trade show, conference, sporting event, concert, festival, political event, among others. While fewer EFOs may be generated during the event. Similarly, relatively more EFOs may be generated prior to an event such that the arrival of the EFOs is before or close to the start of the event. While fewer EFOs may be generated during or significantly before the event.

Additionally or alternatively, the separation of time between EFOs may seek to strike a balance between a large number of EFOs providing granularity of flight options to potential passengers to not overwhelming flight scheduling systems and market places with too large a number of EFOs or causing potential passengers to be overwhelmed by too many choices. Additionally or alternatively, depending on the variables discussed throughout this disclosure among others not discussed, there is a balance that may be struck on EFO granularity that may lead to flight consolidation. For example, a first level of EFO granularity may cause separate potential passengers to come together to identify one EFO or relatively closely situated EFOs such that the separate potential passengers may ultimately fly together. Flying together may provide the separate potential passengers and/or the operator an increased efficiency that may result in reduced fares and/or increased revenue. Where a second level of EFO granularity, that may be a higher granularity than the first level of EFO granularity, may lead to the separate potential passengers selecting different flights that may lead to decreased efficiency since two separate flights may ultimately be taken. Additionally or alternatively, the system may substitute aircraft of higher or lower capacity to meet the demand for the route.

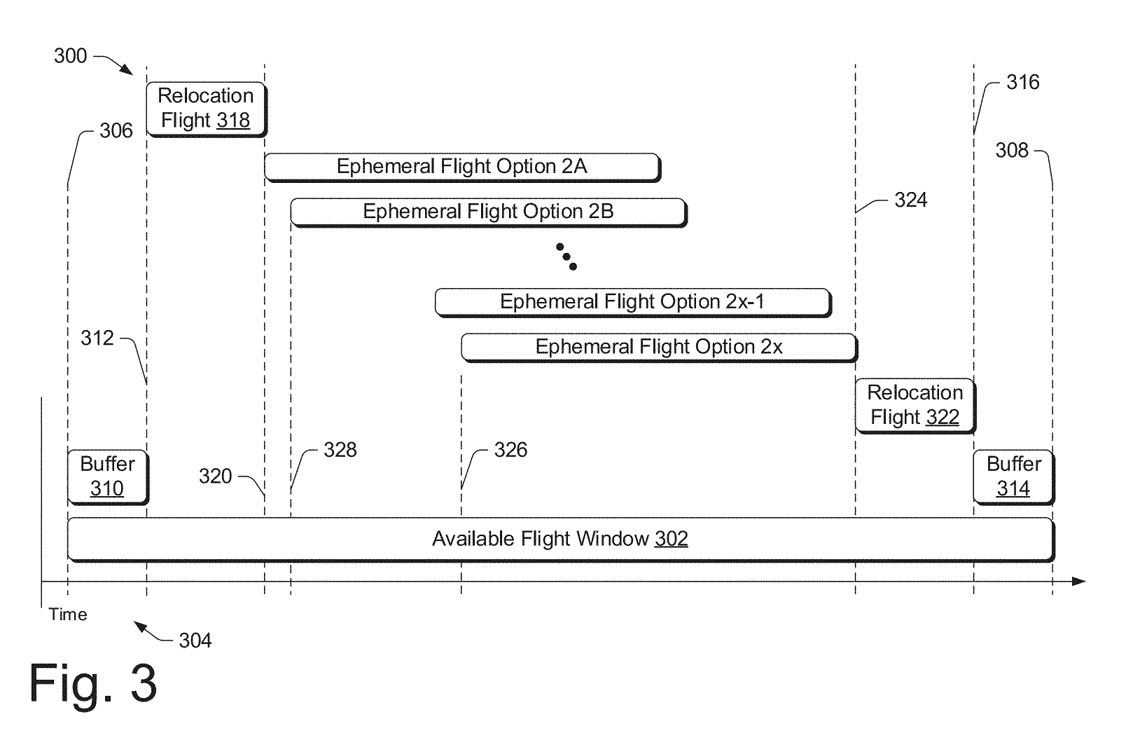

FIG. 3 shows a depiction 300 of an illustrative AFW 302 with illustrative EFOs. For example, FIG. 3 shows AFW 302, on a timeline 304, where the AFW 302 has a beginning time 306 and an ending time 308. This AFW 302 represents the window of time the aircraft may be available for additional flights. AFW 302 may include a buffer 310 of time beginning at time 306 and ending at time 312. Additionally or alternatively, the system may include a buffer 314 that begins at time 316 and ends at time 308. The system may institute buffer 310 and/or buffer 314 based on various considerations. For example, buffers 310 and 314 may provide time for events that are triggered by additional flights within the AFW including but not limited to additional refueling, additional pilot rest, additional aircraft maintenance, additional aircraft preparation or reconfiguration, predicted delays, among others, for example as discussed above. Additionally or alternatively, the beginning and ending times 306 and 308 of AFW 302 may take into account expected buffer times for any predetermined flights, including for example, preparing the aircraft the original chartered flight.

The system may use AFW 302 to begin generating possible ephemeral flight options (EFOs). For example, the system may consider geographic distances, geographic locations, airport configurations, anticipated weather, anticipated head or tail winds, airport congestion, as well as operator preferences, among others to generate possible EFOs. For example, as discussed with respect to FIG. 1, AFW 302 may correspond to an AFW between flights 102 and 108 of a chartered flight. Flight 102 is expected to arrive at or prior to time 306, and flight 108 is expected to depart at or after time 308. Additionally or alternatively, the system may have a set of pregenerated EFOs where the system may filter out EFOs on a per-operator or per-aircraft basis.

In this example, in addition to offering flights with departure and/or arrival windows, the system may generate EFOs. For example, with AFW 302 and associated flight information, preferences, etc, the system may generate any number of possible ephemeral flight options originating from location B and arriving at another location, for example location D. Additionally or alternatively, the system may identify a flight between location D and location E to based ephemeral flights on. Since the aircraft will be at location B at the beginning of AFW 302, the system takes into account a relocation flight 318 from location B to location D arriving at time 320. Similarly, the system will take into account a relocation flight 322 from location E to location B leaving location E not later than time 324.

With this additional information, the system may generate EPOs. For example, the system may generate EFO 2A, EFO 2B, . . . EFO 2x as shown in FIG. 3 where x may be any discrete number. In this example, each EFO may have a different departure time and arrival time. For example, EFO 2A may depart at time 320 where EFO 2x may depart at time 326 and arrive at time 324. Various embodiments contemplate that the number of EFOs x may be based on several factors, for example, similar to the factors discussed above. These factors may determine the departure time 328 of EFO 2B.

Additionally or alternatively, in the this example, relocation flights 318 and 322 may be considered empty leg flights of flight 136 from location D to location E. As such, the system may generate EFOs based on flight 124 from location B to location D and flight 132 from location E to location B. The system may define effective AFWs for each flight 124 and flight 136. For example, an effective AFW for flight 124 may range from time 312 to time 326. This allows time for flight 136 and flight 132 to return the aircraft to location B. Additionally or alternatively, this approach may be expanded for additional locations not shown in FIGS. 1 and 3 and combinations between the various locations.

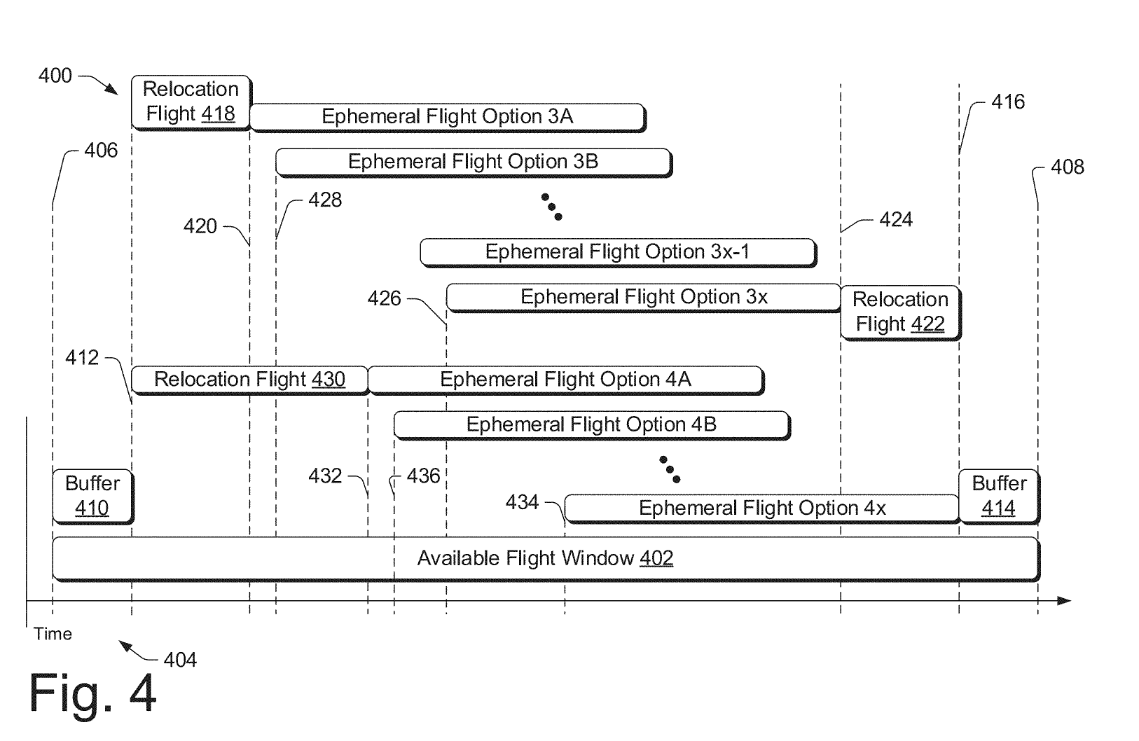

FIG. 4 shows a depiction 400 of an illustrative AFW 402 with illustrative EFOs. For example, FIG. 4 shows AFW 402, on a timeline 404, where the AFW 402 has a beginning time 406 and an ending time 408. This AFW 402 represents the window of time the aircraft may be available for additional flights. AFW 402 may include a buffer 410 of time beginning at time 406 and ending at time 412. Additionally or alternatively, the system may include a buffer 414 that begins at time 416 and ends at time 408.

The system may use AFW 402 to begin generating possible ephemeral flight options (EFOs). For example, the system may consider geographic distances, geographic locations, airport configurations, anticipated weather, anticipated head or tail winds, airport congestion, predicted demands as well as operator preferences, among others to generate possible EFOs. For example, as discussed with respect to FIG. 1, AFW 402 may correspond to an AFW between flights 102 and 108 of a chartered flight. Flight 102 is expected to arrive at or prior to time 406, and flight 108 is expected to depart at or after time 408.

In this example, in addition to offering flights with departure and/or arrival windows, the system may generate EFOs. For example, with AFW 402 and associated flight information, preferences, etc, the system may generate any number of possible ephemeral flight options originating from location B and arriving at another location, for example location D. Additionally or alternatively, the system may identify a flight between location D and location E to based ephemeral flights on. Since the aircraft will be at location B at the beginning of AFW 402, the system takes into account a relocation flight 418 from location B to location D arriving at time 420. Similarly, the system will take into account a relocation flight 422 from location E to location B leaving location E not later than time 424. For example, a consumer may see or indicate an “arrive by” time or “arrive not later than” time.

With this additional information, the system may generate EPOs. For example, the system may generate EFO 3A, EFO 3B, . . . EFO 3x as shown in FIG. 4 where x may be any discrete number. In this example, each EFO may have a different departure time and arrival time. For example, EFO 3A may depart at time 420 where EFO 3x may depart at time 426 and arrive at time 424. Various embodiments contemplate that the number of EFOs x may be based on several factors, for example, similar to the factors discussed above. These factors may determine the departure time 428 of EFO 3B.

Additionally or alternatively, the system may identify a flight between location E and location B to based ephemeral flights on. Since the aircraft will be at location B at the beginning of AFW 402, the system takes into account a relocation flight 430 from location B to location E arriving at time 432. With this information, the system may generate EFO 4A, EFO 4B, . . . EFO 4x as shown in FIG. 4. In this example, each EFO may have a different departure time and arrival time. For example, EFO 4A may depart at time 432 where EFO 4x may depart at time 434 and arrive at time 416. Various embodiments contemplate that the number of EFOs x may be based on several factors, for example, similar to the factors discussed above. These factors may determine the departure time 436 of EFO 4B.

Additionally or alternatively, in the this example, relocation flight 418 and 422 may be considered empty leg flights of flight 136 from location D to location E and flight 430 may be considered an empty leg flight of flight 132 from location E to location B. As such, the system may generate EFOs based on flight 124 from location B to location D, flight 132 from location E to location B, and flight 130 from location B to location E. The system may define effective AFWs for each flight 124, flight 136, and flight 130. For example, an effective AFW for flight 124 may range from time 412 to time 426. This allows time for flight 136 and flight 132 to return the aircraft to location B. Additionally or alternatively, this approach may be expanded for additional locations not shown in FIGS. 1 and 4 and combinations between the various locations. Similarly, an effective AFW for flight 130 may range from time 412 to time 434. This allows time for flight 132 to return the aircraft to location B.

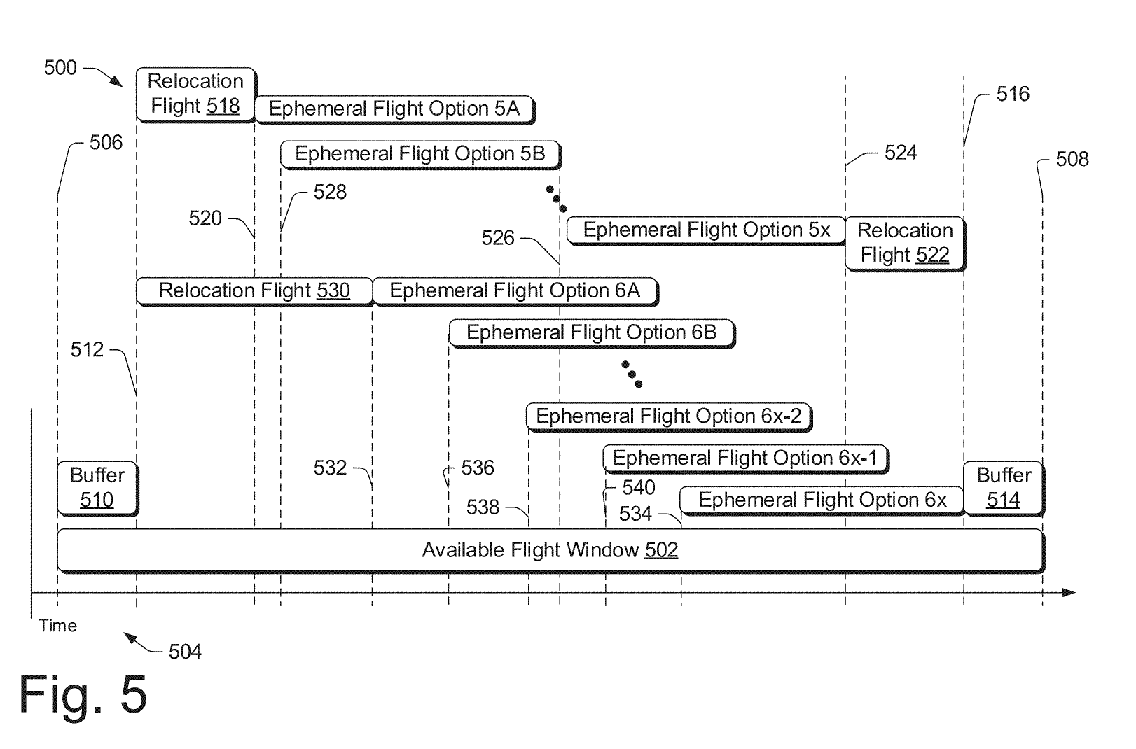

FIG. 5 shows a depiction 500 of an illustrative AFW 502 with illustrative EFOs. For example, FIG. 5 shows AFW 502, on a timeline 504, where the AFW 502 has a beginning time 506 and an ending time 508. This AFW 502 represents the window of time the aircraft may be available for additional flights. AFW 502 may include a buffer 510 of time beginning at time 506 and ending at time 512. Additionally or alternatively, the system may include a buffer 514 that begins at time 516 and ends at time 508.

The system may use AFW 502 to begin generating possible ephemeral flight options (EFOs). For example, the system may consider geographic distances, geographic locations, airport configurations, anticipated weather, anticipated head or tail winds, airport congestion, as well as operator preferences, among others to generate possible EFOs. For example, as discussed with respect to FIG. 1, AFW 502 may correspond to an AFW between flights 102 and 108 of a chartered flight. Flight 102 is expected to arrive at or prior to time 506, and flight 108 is expected to depart at or after time 508.

In this example, in addition to offering flights with departure and/or arrival windows, the system may generate EFOs. For example, with AFW 502 and associated flight information, preferences, etc, the system may generate any number of possible ephemeral flight options originating from location B and arriving at another location, for example location D. Additionally or alternatively, the system may identify a flight between location D and location E to based ephemeral flights on. Since the aircraft will be at location B at the beginning of AFW 502, the system takes into account a relocation flight 518 from location B to location D arriving at time 520. Similarly, the system will take into account a relocation flight 522 from location E to location B leaving location E not later than time 524.

With this additional information, the system may generate EFOs. For example, the system may generate EFO 5A, EFO 5B, . . . EFO 5x as shown in FIG. 5 where x may be any discrete number. In this example, each EFO may have a different departure time and arrival time. For example, EFO 5A may depart at time 520 where EFO 5B may arrive at time 526 and depart at time 528. Various embodiments contemplate that the number of EFOs x may be based on several factors, for example, similar to the factors discussed above. These factors may determine the departure time 528 of EFO 5B.

Additionally or alternatively, the system may identify a flight between location E and location B to based ephemeral flights on. Since the aircraft will be at location B at the beginning of AFW 502, the system takes into account a relocation flight 530 from location B to location E arriving at time 532. With this information, the system may generate EFO 6A, EFO 6B, . . . EFO 6x as shown in FIG. 5. In this example, each EFO may have a different departure time and arrival time. For example, EFO 6A may depart at time 532 where EFO 6x may depart at time 534 and arrive at time 516. Various embodiments contemplate that the number of EFOs x may be based on several factors, for example, similar to the factors discussed above. These factors may determine the departure time 536 of EFO 6B. Similarly, EFO 6x-2 may depart at time 538, while EFO 6x-1 may depart at time 540.

In this example, EFOs 5A through 6x are generated and made available to potential passengers. As discussed elsewhere in this disclosure, the EFOs may be made available through various avenues. For example, they may be published on a flight distribution market place, various social media outlets, among others. For purposes of this example, after the EFOs are made available, a potential passenger books EFO 5B. Various embodiments contemplate that upon booking EFO 5B, the system may identify which EFOs to delist, retract, or cancel depending on how the EFOs were made available to potential passengers. FIG. 5 shows EFO 5B departs at 528 from location D and arrives at 526 at location E. Here, the system identifies that EFOs 5A, 5C-5x are no longer available. Additionally, the system identifies that relocation flight 530, EFO 6A-6x-2 are no longer available. However, the system may identify that EFOs 6x-1 and 6x are still available since the aircraft will arrive at location E prior to the respective departure times of 540 and 534. As such, the system may delist, retract, or cancel EFOs 5A, 5C-5x, relocation flight 530, and EFO 6A-6x-2 (depending on how the EFOs were made available to potential passengers). Additionally or alternatively, the system may republish, repost, redistribute, or emphasize EFOs 6x-1 and 6x. Additionally or alternatively, the system may do a combination of delisting (and the like) and republishing (and the like). Additionally or alternatively, the system may promote or boost certain legs that the operator is keen to sell.

Various embodiments contemplate that this process may repeat as various EFO become unavailable over time. For example, various EFOs may become unavailable due to the booking of conflicting EFOs as discussed above, as well as changes in an operator's preferences, changes in available aircraft, changes in weather, changes in available airports, changes in scheduled events, changes in chartered flights, among others.

Illustrative Flight Windows

In this illustrative example, when a Departure Airport=Arrival Airport, they system may treat this as a transient window. Here, Airport A is the airport that aircraft is transient at (available for a flight within a window) where Airport B is an alternate airport where aircraft could go. In this example, the pricing may be based at least in part on PriceA−B=PriceB−A=HourlyRate*(ETEA−B+ETEB−A)+Feesairport B+Feesairport A. Here, the system may propose to leave Airport A fees out of the calculation for simplicity. Similarly, for simplicity, the system need not collect a “Minimum Price,” for example, it may be set to 0. Here the system may set a radius for transient search based at least in part on definitions at the Operator level, for example, 1000 nm as default value, where the operator may change it. Further, in this example, the pricing for overnight and homebases is ignored for simplicity.

In this example, an aircraft is “transient” when it is away from its homebase. It is sitting at an airport, having dropped off a passenger or is simply waiting for a new passenger to book it. The difference between a repositioning flight window and a transient flight window may be described as: repositioning flight window: Aircraft has to go from A to B. A→B, a “minimum price” can be assigned. While a transient flight window: Aircraft is at A and will remain at A (A→A), but it could go A→B→A. Where Pricing may depend on what B is, and how much cost the aircraft is incurring to sit at A.

In this example some pricing differences may be based, at least in part, on a repositioning flight window, where the repositioning flight window may capture a need for an aircraft to go from A to B. The aircraft has to make that trip. The cost might be covered by another passenger (it's revenue recovery exercise) or it could just be a new flight that the operator is incurring to get their aircraft to the “right” or a desired location. The price can be captured as a minimum price because the price for A to B is not necessarily the actual DOC. Rather, it may simply be simply the amount the operator requires for the flight from A to B to happen. Any additional cost incurred (for a flight option) may to be compensated at the full hourly rate.

In the case of a Transient flight window, there is no specific route to assign a minimum price to. The price is dependent on what airport “B” is. If the aircraft is incurring costs by being away from homebase, those may be subtracted from the DOC. If the aircraft is incurring costs specific to sitting at airport “A”, those may be subtracted from the DOC.

Here, for simplicity, the example ignores the subtraction of costs, and just gives the operator a “transient hourly rate” which ignores the subtraction of costs. Here the system may give the operator a “transient hourly rate” which he can control each time entering a transient flight window. That rate could be higher or lower than operator's standard hourly rate for the aircraft. The system may then generate the possible “B”s (flight options from A−B−A) and price as flight time+fees for each segment.

Various embodiments contemplate using the full hourly rate, and ignoring any cost savings. For example, the system may use the full hourly rate, and try to estimate and then subtract anticipated transient costs. Here, the system may identify a transient window because airport A=airport A. We can identify a homebase window because airport A=airport A & airport A=aircraft homebase airport.

Here the system may identify possible B's within a circle of a given radius. Radius could be a function of the range of an aircraft, or default distance. In this example, when the system has the set of possible B's { }, the system may calculate the price of each flight segment A−B and B−A as PriceA−B=PriceB−A=HourlyRate*(ETEA−B+ETEB−A)+Feesairport B+Feesairport A.

However, in an example, where there are multi-day pricing with overnights, system may use Transient Windows: PriceA−B=PriceB−A=HourlyRate*(ETEA−B+ETEB−A)+Feesairport B+Feesairport A, where the Homebase Windows: PriceA−B=PriceB−A=HourlyRate*(ETEA−B+ETEB−A)+Feesairport B+Feesairport A*Nights at B*Overnight Rate

In this example, the pricing difference between Transient and Homebase windows may be caused since in the case of a transient window, the overnight cost is already being incurred by whoever created and paid for the transient opportunity. While an aircraft at homebase has no penalty for staying at homebase. When an aircraft leaves homebase, the new buyer may have to pay for any overnight charges he incurs at B, if he keeps the aircraft at B overnight.

Illustrative Operating Systems and Methods

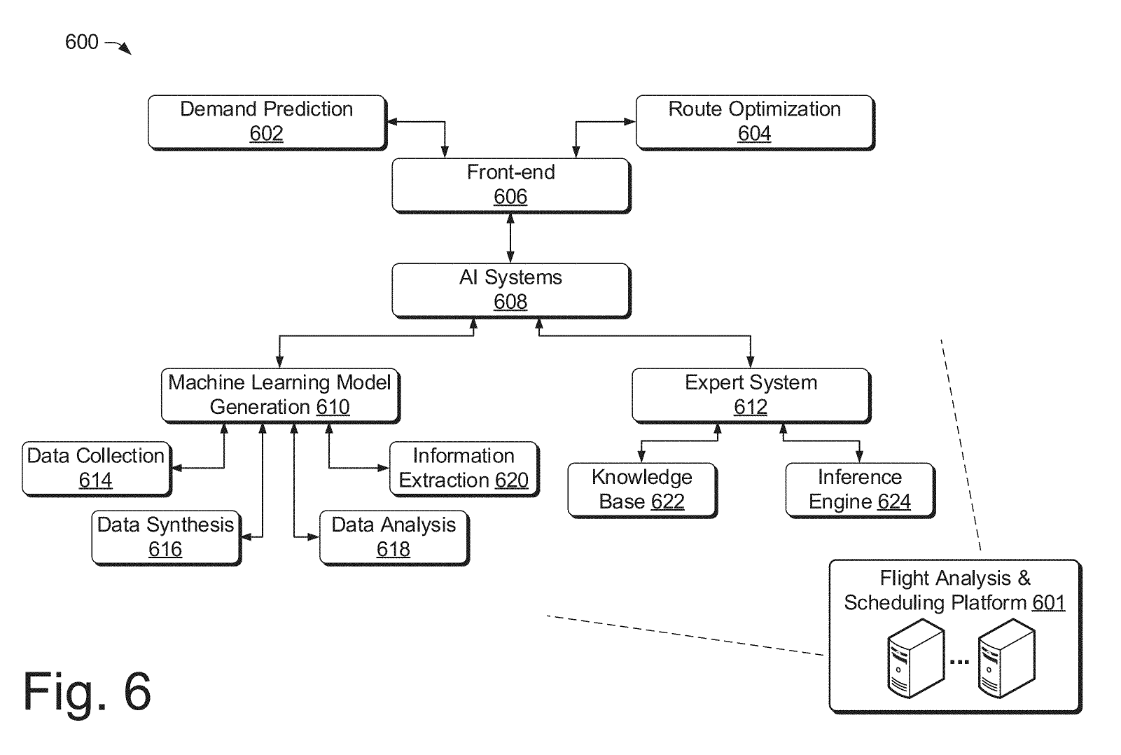

FIG. 6 shows an illustrative system 600 supporting flight analysis & scheduling platform 601. For example, system 600 may include a demand prediction module 602 that may use information from various sources to provide demand predictions. Additionally, system 600 may also include route optimization module 604 that may generate or filter routes to provide EFOs. Various embodiments contemplate that demand prediction module 602 and route optimization module 604 may be in communication with front-end 606 to coordinate communication with the various modules and users. Additionally, front end 606 may be connected to an artificial intelligent (AI) system 608 to provide EFOs. For example, AI system 608 may be coupled to a machine learning model generation module 610 and an expert system module 612. For example, the machine learning model generation module 610 may use data collection module 614, data synthesis module 616, data analysis module 618 and information extraction module 620 to generate a machine learning model that may be leveraged to generate EFOs as discussed. Additionally, expert system 612 may use a knowledge base module 622 and an inference module 624 to further support the AI systems 608 to generate and filter EFOs.

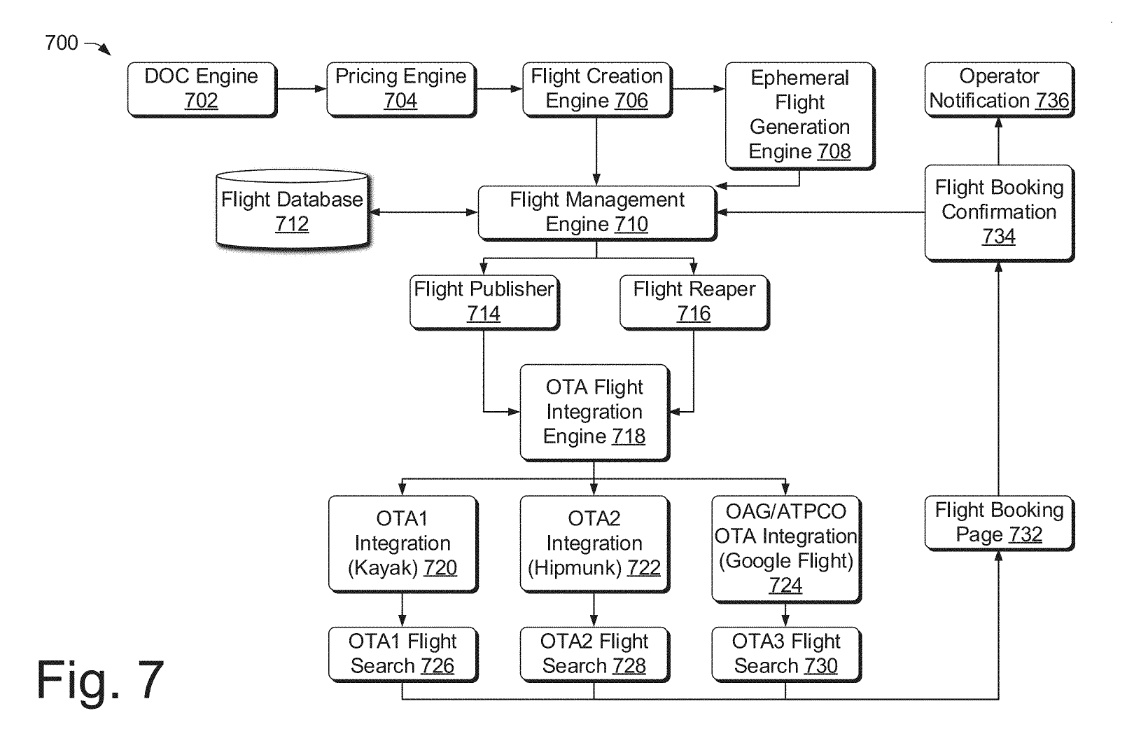

FIG. 7 shows an illustrative flight listing generation system 700. For example, flight listing generation system 700 may include a direct operating cost (DOC) engine 702 for an aircraft to generate an estimate of direct operating costs, for example, to take into account if additional repositioning flight is required. Various embodiment contemplate that a pricing engine 704 may use a DOC from the DOC engine 702 as an input in generating a minimum acceptable price for a flight. However, as discussed, the DOC may or may not be taken into account in determining a minimum acceptable price for a flight. Various embodiments contemplate that a flight creation engine 706 may generate a flight, for example, a flight set by an operator, based at least in part on information from the DOC engine 702 and pricing engine 704. Various embodiments contemplate that the generated flight from the flight creation engine 706 may be used by the ephemeral flight generation engine 708 to generate one or more EPOs as discussed. The flight listing generation system 700 may also have a flight management engine 710 that may take information from the flight creation engine 706 and the ephemeral flight generation system engine 708 as well as additional information from flight database 712 to manage flight listings. Additionally or alternatively, the flight management engine 710 may store or receive information from flight database 712. Various embodiments contemplate that the flight management engine 710 may coordinate with flight publisher 714 and flight reaper 716 to control flight listings on various platforms. For example, flight publisher 714 may be configured to provide a list of a subset of EFOs generated by the system to an online travel agency (OTA) flight integration engine 718 to list the flights on OTAs. Additionally or alternatively, flight reaper 716 may be configured to provide a list of flights to be removed from an OTA, for example, when flight is sold or canceled, the sold flight and/or one or more conflicting EFOs may be removed. However, various embodiments contemplate that an otherwise conflicting EFO might not be removed from an OTA, for example, when another operator is available to support the EFO.

FIG. 7 also shows the illustrative OTA flight integration engine 718 in communication with OTA integration modules 720, 722, and 724, which may be connected to OTA flight search providers 726, 728, and 730 to list the flights on the respective OTAs systems. Additionally, when a flight is booked through flight booking page 732 and confirmed through flight booking confirmation 734, the operator may be notified through operation notification 736 as well as the flight may be confirmed as booked with the flight management engine 710 which may cause ephemeral flight generation engine 708 to generate additional EFOs for listing. Additionally or alternatively, the flight management engine 710 may cause the flight reaper 716 to remove the booked flight and/or conflicting EFOs from the OTAs.

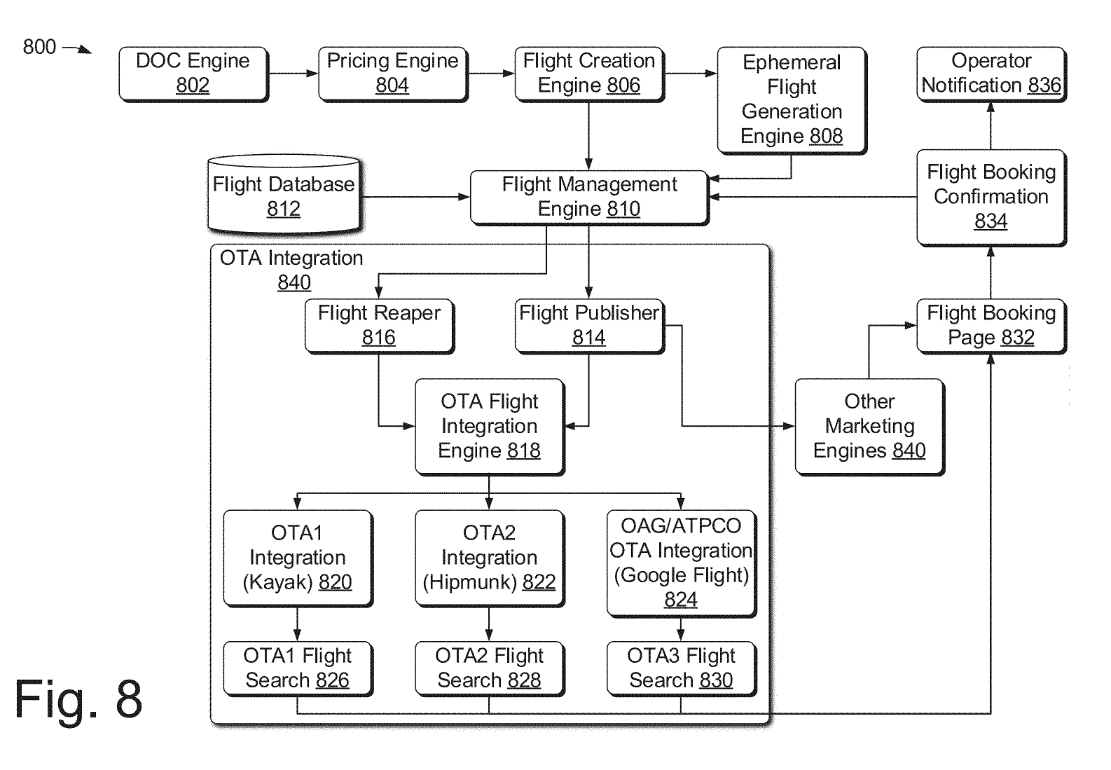

FIG. 8 shows an illustrative flight listing generation system 800 similar to flight listing generation system 700, where similar named and numbered modules perform similar roles as those discussed with respect to FIG. 7. However, FIG. 8 shows that several modules are integrated into an OTA integration module 840 where the flight publisher 814 may also provide flight information to other marketing engines 842 to market and sell one or more flights.

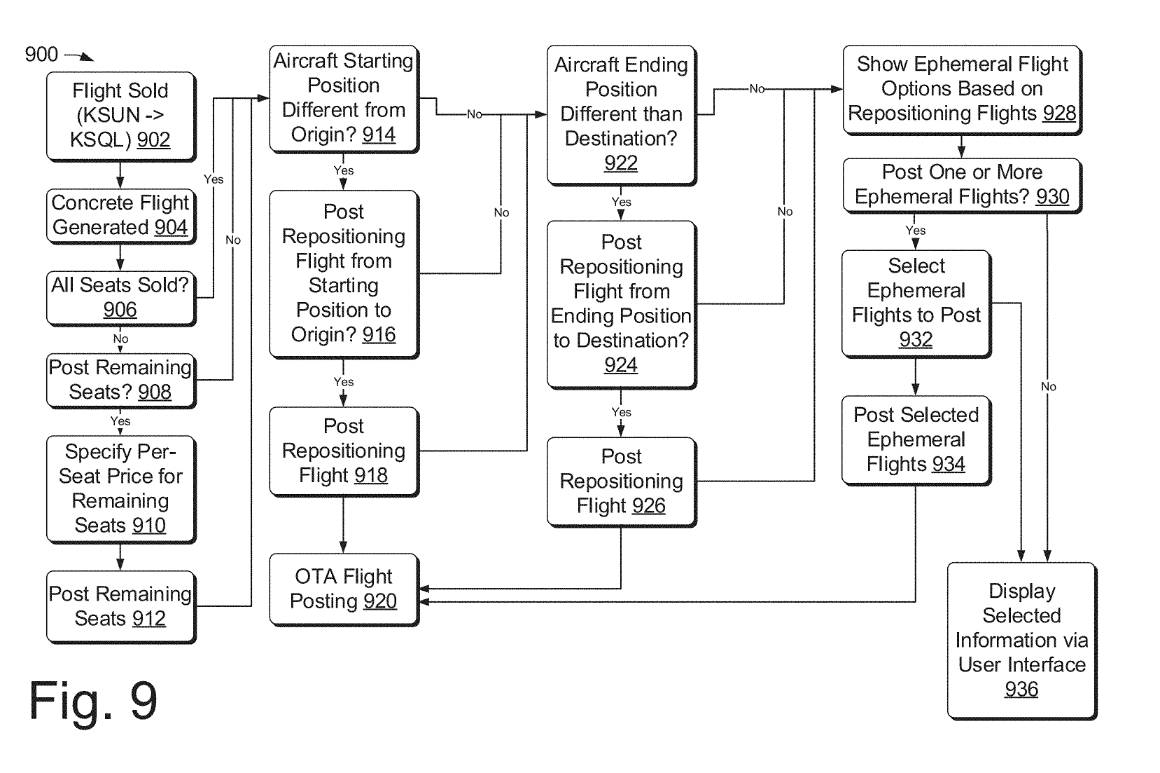

FIG. 9 shows an illustrative flow chart 900 where a flight is sold and EFOs are generated based on the flight. For example, at 902, a flight may be sold by an operator from Sun Valley to San Carlos, where the plane starts in Boise (origin Sun Valley, Destination San Carlos). In this example, the customer may for all of the seats.

At 904, the flight is sold and may be considered to be “concrete” in the respects that it has been sold and confirmed and is not speculative. However, various embodiments contemplate that the sold flight need not be sold or otherwise concrete. For example, the flight may merely be desired by an operator or suspected to be desired by a customer.

At 906, the system may determine whether all of the seats of the flight are sold, if they are not all sold, then the system may look to post the remaining seats at 908. If it is determined that the additional seats should be posted, then at 910, a price for the seats may be determined and the seats may be posted at 912. Various embodiments contemplate that the price for the additional seats may, but need not, be based on the price of the original flight booking. Further, however, at 906, if the seats are all sold or an 908, if the seats are not to be posted, or after the seats are posted at 912, the system may progress to 914, where the system may determine whether the aircraft starting position is different from the origin. If the starting position, for example, Boise, is different from the origin, Sun Valley, then the system determines whether the repositioning flight should be posted at 916. If it is to be posted, then the flight is posted at 918, for example through OTA flight posting at 920. However, if the starting position is not different from the origin at 914 or if the repositioning flight is not to be posted at 916, then, at 922, the system determines whether the ending position is different from the destination. If it is different, for example, destination San Carlos, is different from the ending position of Boise, then, at 924 the system determines whether the repositioning flight from the destination to the end position should be posted. At 926, if it is to be posted, then the repositioning flight may be posted, for example on a OTA flight posting at 920. However, if the end position is not different from the destination, or the repositioning flight is not to be published, then, at 928, they system may show EFO based on any of the repositioning flights. At 930, the system determine whether one or more of the EFOs are to be posted. At 932, if they are, then a subset of EFOs may be selected for posting at 934, through, for example, OTA flight posting at 920. At 930, if no EFOs are to be posted, or at 932, if one or more EFOs are selected for posting, then, at 936, selected information may be displayed through a user interface. Additionally or alternatively, various embodiments contemplate that the user interface may be updated with information throughout or at other times in flow chart 900.

Illustrative Computing Device and Illustrative Operational Environment

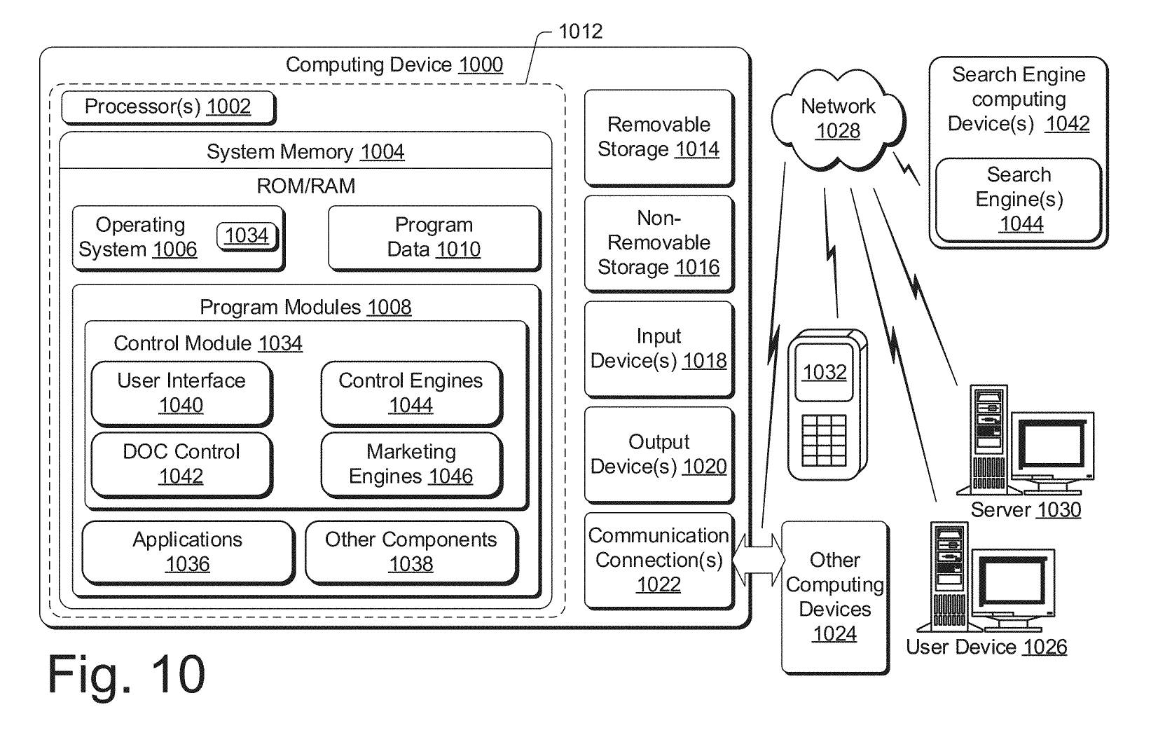

FIG. 10 illustrates a representative computing device 1000 that may, but need not necessarily be used to, implement the system and methods described herein, in accordance with various embodiments. The techniques and mechanisms described herein may be implemented by multiple instances of the computing device 1000, as well as by any other computing device, system, and/or environment. The computing device 1000 shown in FIG. 10 is only one example of a computing device and is not intended to suggest any limitation as to the scope of use or functionality of any computing device utilized to perform the processes and/or procedures described above.

In at least one configuration, the computing device 1000 includes at least one processor 1002 and system memory 1004. The processor(s) 1002 may execute one or more modules and/or processes to cause the computing device 1000 to perform a variety of functions. In some embodiments, the processor(s) 1002 may include a central processing unit (CPU), a graphics processing unit (GPU), both CPU and GPU, or other processing units or components known in the art. Additionally, each of the processor(s) 1002 may possess its own local memory, which also may store program modules, program data, and/or one or more operating systems.

Depending on the exact configuration and type of the computing device 1000, the system memory 1004 may be volatile (such as RAM), non-volatile (such as ROM, flash memory, miniature hard drive, memory card, or the like) or some combination thereof. The system memory 1004 may include an operating system 1006, one or more program modules 1008, and may include program data 1010. The operating system 1006 includes a component-based framework 1034 that supports components (including properties and events), objects, inheritance, polymorphism, reflection, and provides an object-oriented component-based application programming interface (API). The computing device 1000 is of a very basic illustrative configuration demarcated by a dashed line 1012. Again, a terminal may have fewer components but may interact with a computing device that may have such a basic configuration.

Program modules 1008 may include, but are not limited to, applications 1036, a control module 1034, a user interface 1040, a DOC control 1042, Control Engines 1044, Marketing Engines 1046, and/or other components 1038.

The computing device 1000 may have additional features and/or functionality. For example, the computing device 1000 may also include additional data storage devices (removable and/or non-removable) such as, for example, magnetic disks, optical disks, or tape. Such additional storage is illustrated in FIG. 10 by removable storage 1014 and non-removable storage 1016.

The storage devices and any associated computer-readable media may provide storage of computer readable instructions, data structures, program modules, and other data. Computer-readable media includes, at least, two types of computer-readable media, namely computer storage media and communication media.

As used herein, “computer-readable media” includes computer storage media and communication media.

Computer storage media includes volatile and non-volatile, removable and non-removable media implemented in any method or technology for storage of information, such as computer-readable instructions, data structures, program modules, or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVD) or other optical storage, magnetic cassettes, magnetic tape, magnetic disk storage or other magnetic storage devices, or any other medium that can be used to store information for access by a computing device.

In contrast, communication media may embody computer-readable instructions, data structures, program modules, or other data in a modulated data signal, such as a carrier wave. As defined herein, computer storage media does not include communication media.

Moreover, the computer-readable media may include computer-executable instructions that, when executed by the processor(s) 1002, perform various functions and/or operations described herein.

The computing device 1000 may also have input device(s) 1018 such as a keyboard, a mouse, a pen, a voice input device, a touch input device, etc. Output device(s) 1020, such as a display, speakers, a printer, etc. may also be included.

The computing device 1000 may also contain communication connections 1022 that allow the device to communicate with other computing devices 1024, such as over a network. By way of example, and not limitation, communication media and communication connections include wired media such as a wired network or direct-wired connections, and wireless media such as acoustic, radio frequency (RF), infrared, and other wireless media. The communication connections 1022 are some examples of communication media. Communication media may typically be embodied by computer readable instructions, data structures, program modules, etc.

FIG. 10 also shows a schematic diagram of an illustrative operating environment where an illustrative system may operate. For example, various embodiments of the system may operate on the computing device 1000. The computing device 1000 may interact with a user 1026 directly or indirectly. The computing device may be connected to a network 1028. The network device 1028 may provide access to other computing devices 1024 including a server 1030, mobile devices 1032, and/or other connections and/or resources. Connections may be wired or wireless.

The illustrated computing device 1000 is only one example of a suitable device and is not intended to suggest any limitation as to the scope of use or functionality of the various embodiments described. Other well-known computing devices, systems, environments and/or configurations that may be suitable for use with the embodiments include, but are not limited to, personal computers, server computers, hand-held or laptop devices, multiprocessor systems, microprocessor-based systems, set top boxes, game consoles, programmable consumer electronics, network PCs, minicomputers, mainframe computers, distributed computing environments that include any of the above systems or devices, implementations using field programmable gate arrays (“FPGAs”) and application specific integrated circuits (“ASICs”), and/or the like.

The implementation and administration of a shared resource computing environment on a single computing device may enable multiple computer users to concurrently collaborate on the same computing task or share in the same computing experience without reliance on networking hardware such as, but not limited to, network interface cards, hubs, routers, servers, bridges, switches, and other components commonly associated with communications over the Internet, as well without reliance on the software applications and protocols for communication over the Internet.

Illustrative System and Operational Environment

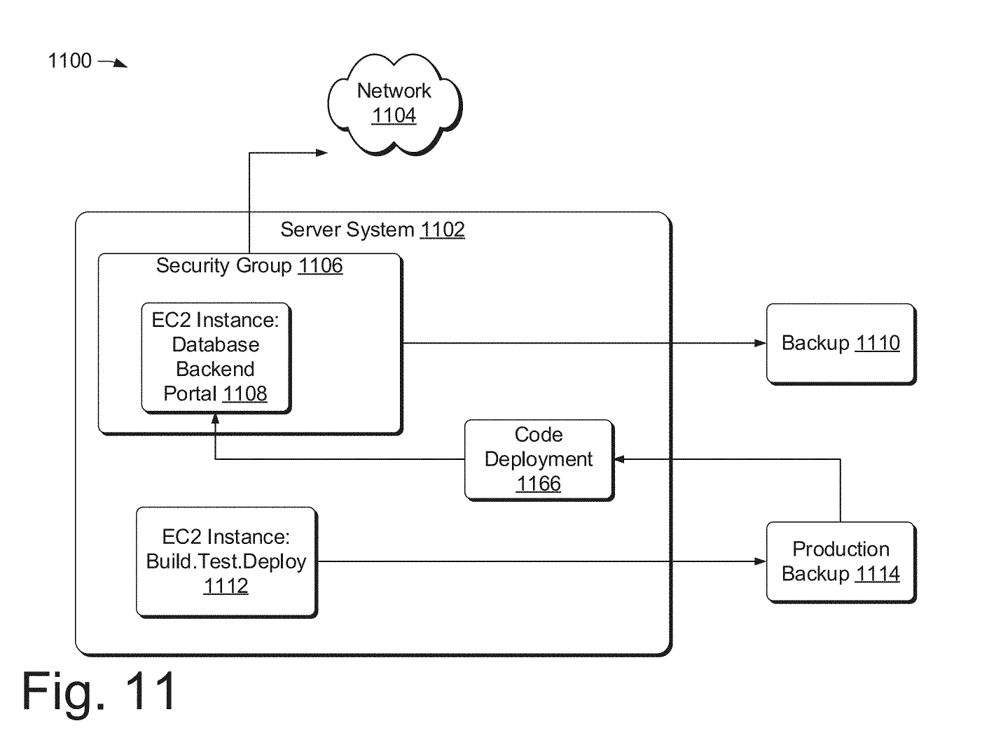

FIG. 11 shows an illustrative operation environment 1100, where a server system 1102 may be connected to a network 1104 for communication with users and/or operators. Server system 1102 may host a security group 1106 that may include a system instance 1108, for example, a scalable computation system, for example, and elastic compute cloud. For example, the system instance 1108 may a database, backend modules, as well as one or more portals. Additionally or alternatively, the security group 1106 may be regularly backed up on backup 1110. Additionally or alternatively, the server system 1102 may also have another system instance 1112. For example, system instance 1112 may include features configured to build, test, and/or deploy systems, for example, upgrades to instance 1108. Additionally or alternatively, the system instance 1112 may be regularly backed up on production back up 1114. When desired, the new production instance may be sent to a code deployment module 1116 to update instance 1108.

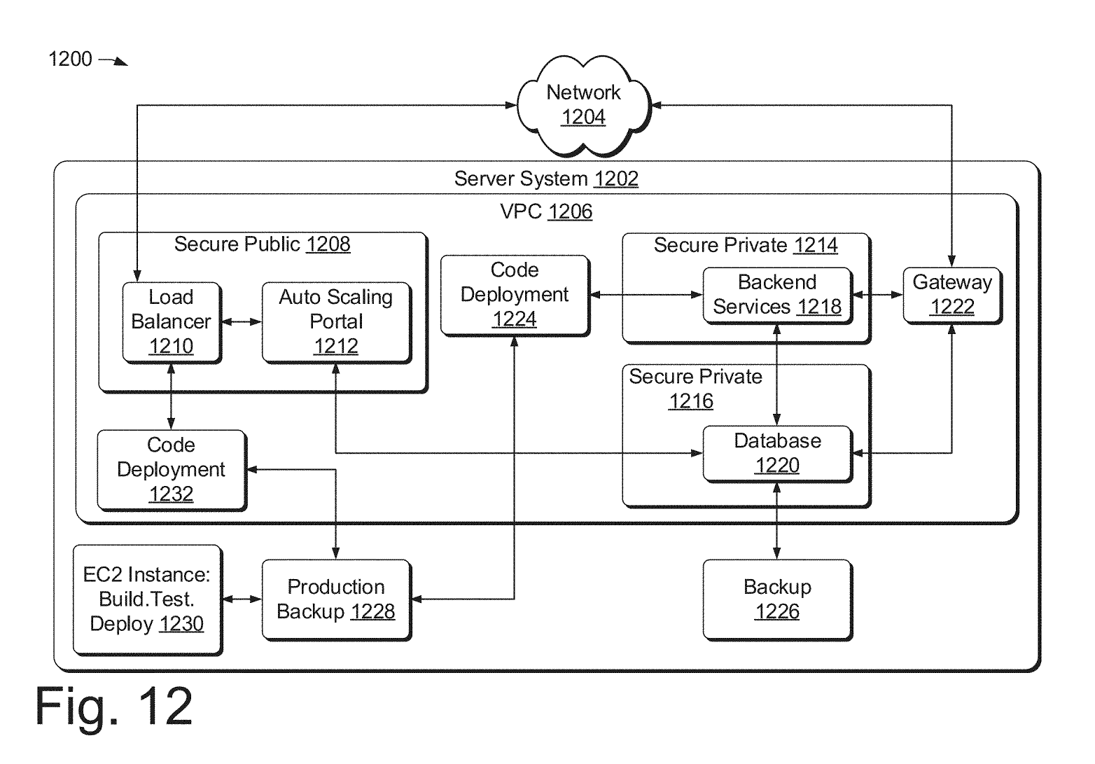

FIG. 12 shows an illustrative system and operation environment 1200, where a server system 1202 may be connected to a network 1204 for communication with users and/or operators. Server system 1202 may host a virtual private cloud (VPC) 1206 that may include a system instance 1208. Here the system instance 1208 may include a secure public access. The system instance 1208 may include a load balancer 1210 as well as an auto scaling portal 1212. Additionally or alternatively, the VPC 1206 may also include secure private system instances 1214 and 1246 where the instance 1214 may include backend services 1218 while instance 1216 may include database 1220. Various embodiments contemplate the VPC 1206 including a gateway 1222 as well as code deployment module 1224. Additionally or alternatively, various embodiments contemplate backups 1226 and 1228 as well as a build/test/deploy system instance 1230. Various embodiments contemplate a code deployment module 1232 that may be used to update the system instance 1208.

Illustrative Fight Generation Example

Commercial aviation customers have been trained to search for flights based on airports and scheduled times. This works well for airlines that are trying to fill planes, but it does not address the real customer need: finding travel options that get them from their current location to their desired location. For example, if a user wants to stay at the Wynn in Las Vegas tonight, they may go to a search engine or an OTA like Google Flights or Kayak, enter in a departure airport, like SFO, and an arrival airport, like LAS. They then select a flight based on price and departure or arrival time.

Illustrative embodiments provide a different workflow. For example, the use may tell the system where they want to go (e.g., Wynn Hotel in Las Vegas) and when they want to be there. The service may present travel options that match this primary goal. Specifically, for example, the service may consult a ride-sharing application, such as Uber to find travel times from nearby airports to the Wynn. As a customer, they might not want the “cognitive load” of trying to figure this out themselves and adjusting the flight times accordingly. Similarly, pricing of these ride-sharing services may affect the user's decision as much as the ride duration, and as a customer, they may want the service to take pricing into account when it presents the options.

This same logic may also be true on the departure side of travel. For example, the customer may want the service to provide them with travel options from the departure location (Home, Work, Hotel, etc.), specifically finding ride-sharing options from the departure location to nearby airport locations.

Additionally, a customer, may be willing to pay more for travel options if they save travel time (or make departure times more agreeable, etc.). For example, it will take 90-120 minutes to drive from Santa Cruz, Calif. to San Francisco, Calif. (SFO airport), and if the user takes an Uber it will cost between $150-$200. Given that ride-sharing cost and travel time, the user may be willing to pay for a private aircraft charter (helicopter, jet, turbo-prop) from Watsonville, Calif. (WVI airport) to SFO.

A flight from WVI→SFO is 20 mins and may cost $200-400, the Uber from the user's house to WVI is 20 mins and costs $30. The customer may like the service to offer the option of paying $50-250 more to save 50-80 minutes travel time.

In addition, the customer may like the service to provide the option of flying out of WVI directly instead of having to go to SFO. Note, this option may cost the customer $0-$400 more than the flight out of SFO (depending on available aircraft proximity to WVI), but they will save 70-100 minutes of travel time to the airport to catch their flight. In this example, the total flight time difference to their destination airport should be no more than 20 mins longer, but it could also be shorter flight, again depending on available aircraft proximity to WVI.

The customer may want the system to evaluate many or all of the travel options and present options based on optimizing overall travel time and options based on optimizing overall price.

Various embodiments of the system may provide estimated time en-route (ETE) for aircraft, and aircraft models, for any route based on actual flights in the flight history database. Flight ETEs may be used extensively for both display and computation purposes. When an operator enters a flight, they specify the origin and destination airports for one of their aircraft. The system may be able to tell them how long that flight will take.

Illustrative ETE Computation

The system may naively compute the ETE based on the known cruising airspeed for their aircraft model, but there are a few limitations with this approach. For example, system would want to have knowledge of standard cruising airspeeds for all aircraft models, and would likely make an assumption about how the operator flies this particular plane (not all operators fly the same routes the same way, not all planes are flown the same way by all pilots, etc.).

However, using actual route flight times by aircraft and aircraft model, may help provide better ETE information for an operator. In some instances, the operator has flown the route for the flight they are entering before with the desired plane multiple times. In that case, the system may then provide a good estimate at the ETE based on what's happened in the past. If their plane hasn't flown this route before, the system may use the aircraft model and look at the ETEs for flights on this route for this aircraft model and provide an estimate based on historical information. The system may also compute airspeeds for each aircraft and aircraft model in the flight history to get a distribution of their airspeeds. However, in an example that the system doesn't have flight history for an operator's aircraft or aircraft model for a route, the system can compute the ETE for this route/plane based on rated airspeed.

Additionally or alternatively, machine learning may be used to predict ETEs for routes, aircraft types, specific aircraft, etc. The system may use a database of historical flights for commercial and GA. The system may use models based on specific aircraft types, specific routes, and specific aircraft. Using deep learning, the system may combine the outputs of these models into a final answer for a given aircraft/route/date-time.

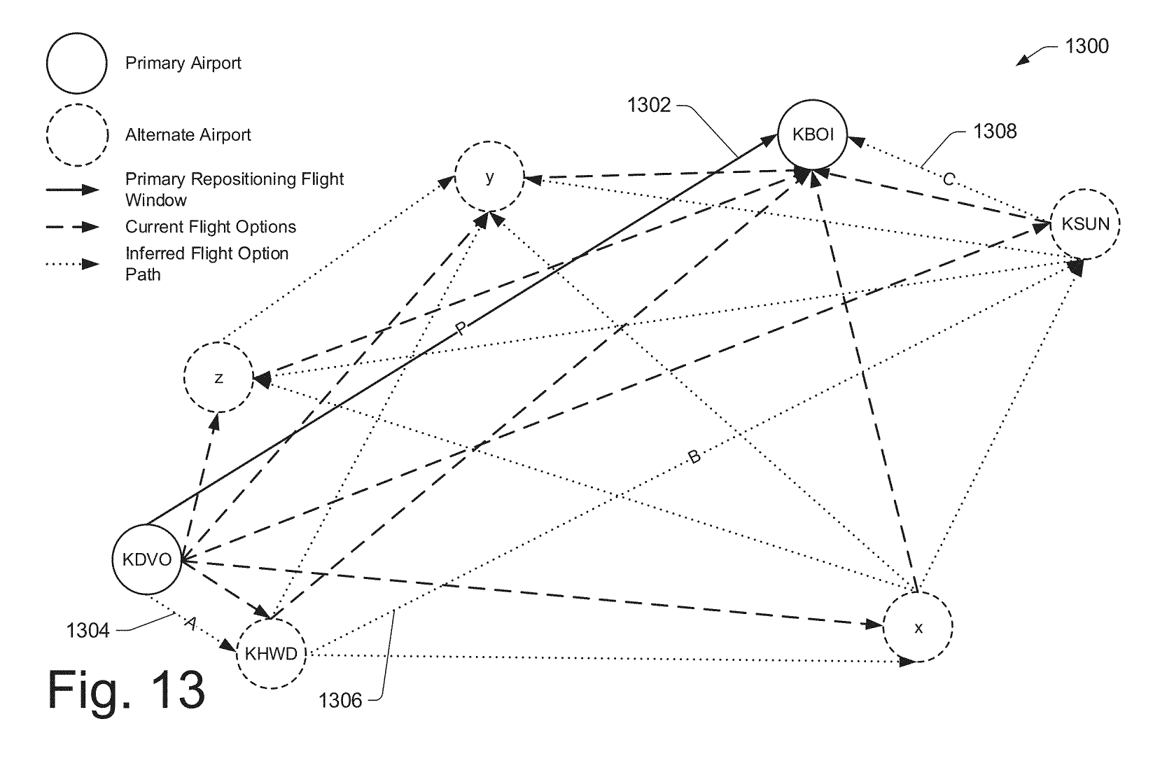

FIG. 13 shows an illustrative example of flight option generation set in an illustrative geographical flight environment 1300. For this illustrative example, there may be a large number of flight options given two locations. For example, there may be hundreds of thousands of flight options for flights in and around KSFO and KBOI.

Here, a radius around the locations is set. This radius may cause nearby airports to be included in the flight options that are generated. In this example, an operator inputs a repositioning leg 1302 of KDVO−KBOI. A customer may request a flight 1306 between KHWD−KSUN. Here, the system may generate a price for flight 1306 based on the following factors: PRICEKHWD−KSUN=[(ETEA+ETEB+ETEC)−ETEP]*HourlyRateaircraft+MinPriceP+FeesKHWD+FeesKSUN, where FeesKSUN and FeesKHWD are fees associated with the airports and have been collected them when pricing KDVOKSUN−KBOI and KDVO−KHWD−KBOI. Additionally, MinPriceP may include the FeesKBOI as that fee may be incorporated in the minimum price concept.

In this example, a consumer may search for a flight based at least in part on some subset of {arrival airport, departure airport, arrival date/time, filters}. The system may then look into flight windows to find the flight windows that contain: dates/time (evaluating whether the flight window matches the necessary date/time that was searched), airports (evaluating whether the flight window contain appropriate airports (either a primary or alternate airport)), filters (evaluating whether the flight window match necessary filters (aircraft class, operator, price)). In this example, for the ones that match, the system may calculate the price of the inferred flight option. For example, calculating route B 1306 in FIG. 13. Where PRICEB=[(ETEA+ETEB+ETEC)−ETEP]*HourlyRateaircraft+MinPriceP+FeesKHWD+FeesKSUN. Based at least in part on this calculation, the results may be shown to the user. In the situation when no results are returned, various parameters may be changed to show additional options.

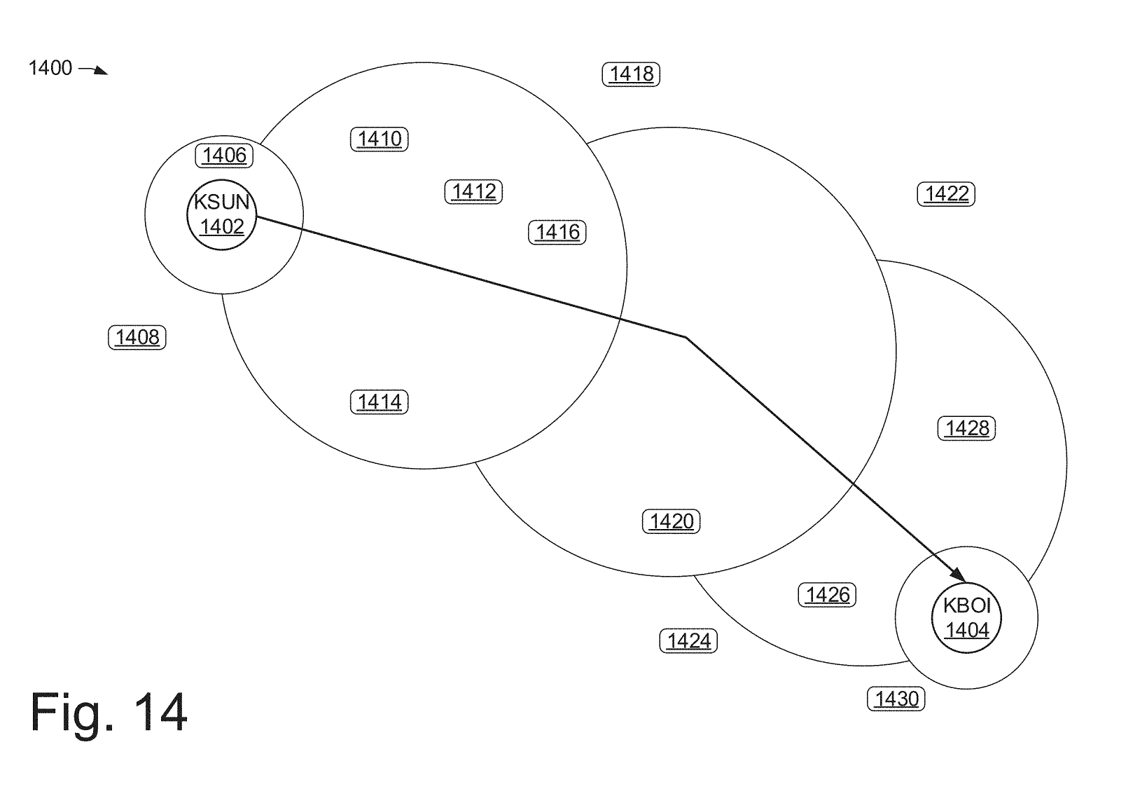

FIG. 14 shows an illustrative geographical operating environment 1400 where ephemeral routes may be generated. For example, an operator may input information that may include, Aircraft, Origin airport, Destination airport, Earliest departure time, Latest arrival time, Minimum price, among others. The system may generate flight time estimates (FLTPlan), based on Aircraft manufacture, Origin airport, Destination airport, Latest arrival time, among others. In this example, the system may generate ephemeral flights based on route course and distance; course is calculated using data base with flight bearing information as well as a database with flight distance information. When course and distance are calculated, the system may split distance on small parts and airports near that airport may be pulled from database. For example, a distance<100 nm=25 nm, a distance<1000 nm=50 nm, a distance<10000 nm=100 nm, and a distance>=10000 nm=200 nm. Here, for KSUN→KBOI, the distance=84 nm, the course=273′, where (84<100)→25 nm, such that the segments: KSUN→25 nm→50 nm→75 nm→KBOI.

As such, FIG. 14 shows airports 1406, 1410, 1412, 1414, 1416, 1420, 1426, and 1428 would be included in the analysis for ephemeral flight generation, while airports 1408, 1418, 1422, 1424, and 1430 would not be included.

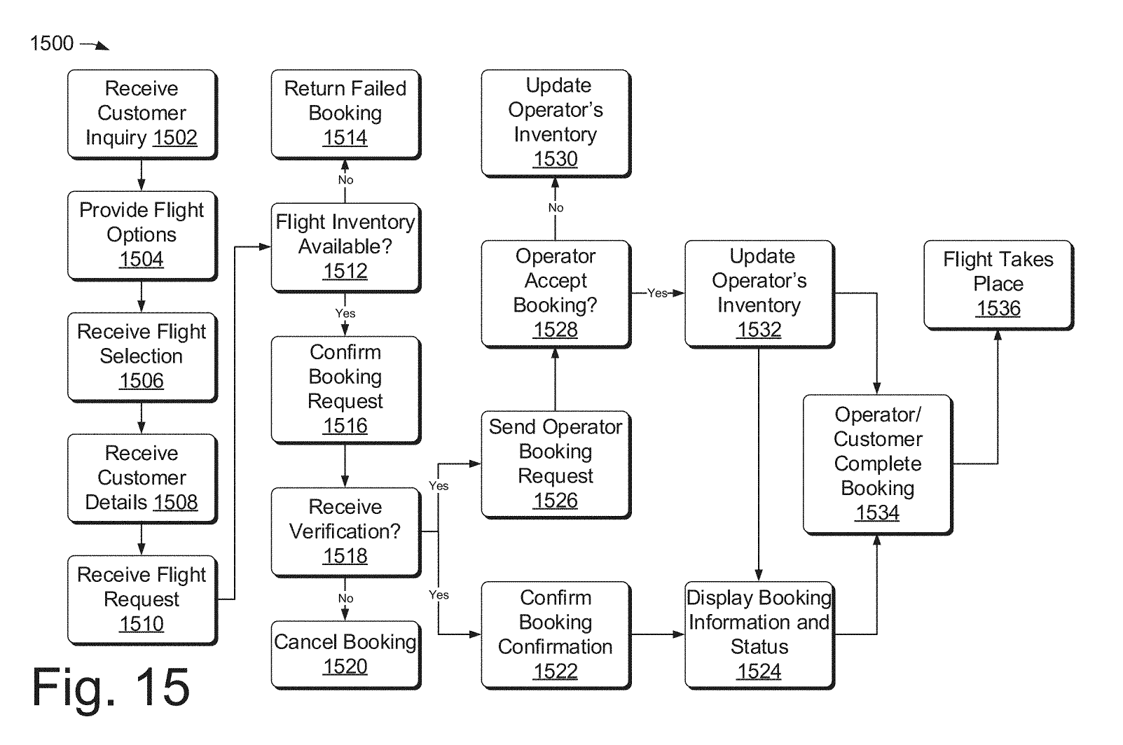

FIG. 15 shows and illustrative flow 1500 where a customer looks for a flight. For example, at 1502, they system may receive a customer inquiry where the system may provide flight options at 1504. After a user selects the flight options, at 1506, the system receives the selection and receives customer details at 1508. If the customer decides to proceed, the system may receive a flight request at 1510. The system may confirm whether the flight is still available at 1512. If the flight is not available, the system may return a failed booking message at 1514. If, however, the flight is available, the system may confirm the booking at 1516. The system may determine whether the user has verified the booking at 1518. If the user does not verify the booking, then the booking may be canceled at 1520. However, if the booking is confirmed, then the confirmation may be confirmed with the user at 1522 and that confirmation may be displayed at 1524 with additional flight information. Additionally, if the booking is confirmed, the system may send the operator the booking request at 1526. Here, they system determines whether the operator accepts the booking at 1528. If the operator does not accept the booking, the operator's inventory may be updated to reflect the removal of that flight. Additionally, the system may determine another operator is available and start at 1526 with the subsequent operator. This may be repeated until an operator is found or operator options exhausted. However, if the operator accepts the booking at 1528, the operator's inventory may be updated to reflect the acceptance of the flight at 1532. This status may be shared at 1524 as well. Additionally or alternatively, the confirmed acceptance and booking may be completed at 1534. At 1536, the flight may take place.

Illustrative User Interfaces

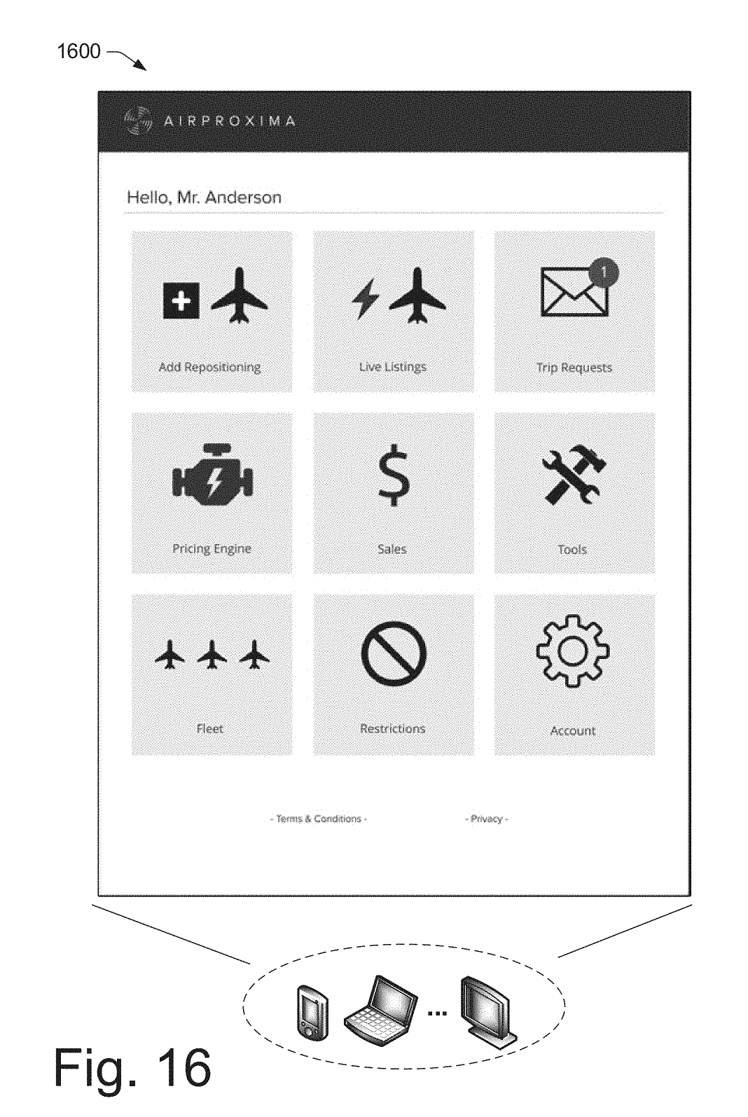

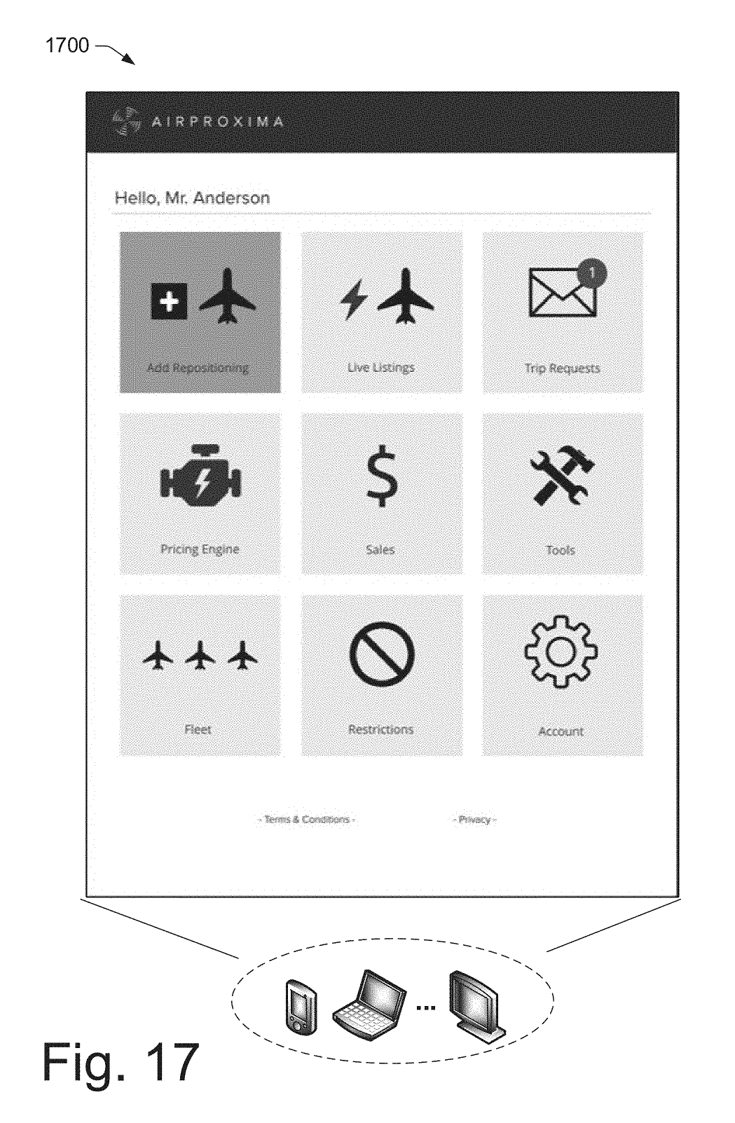

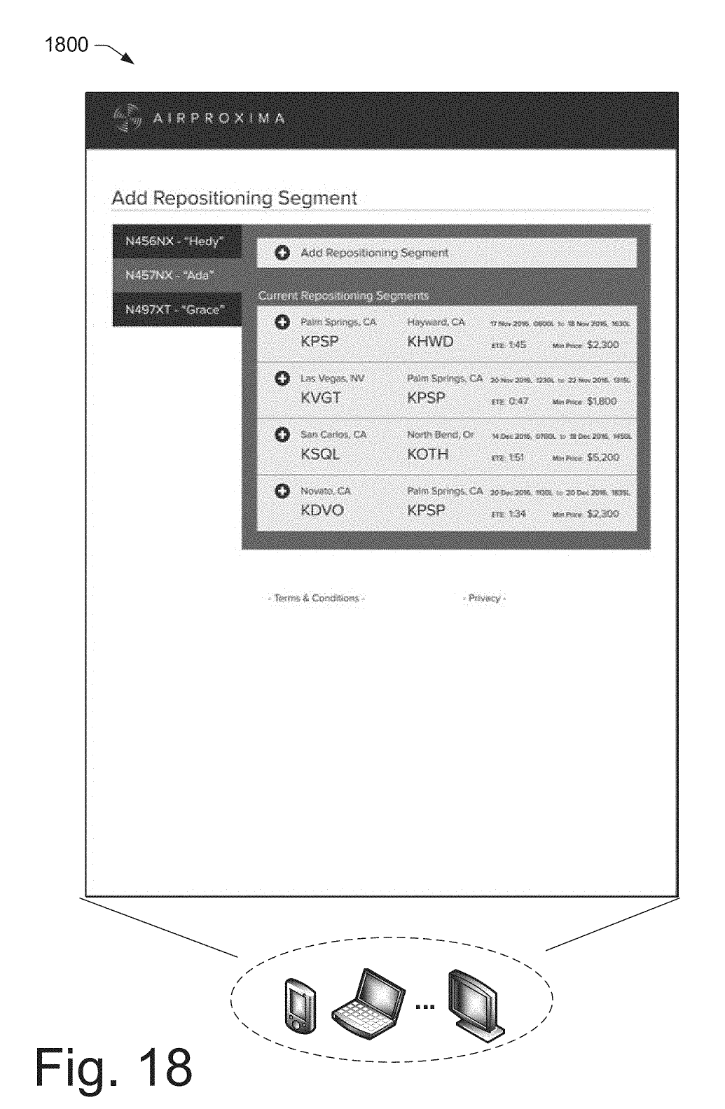

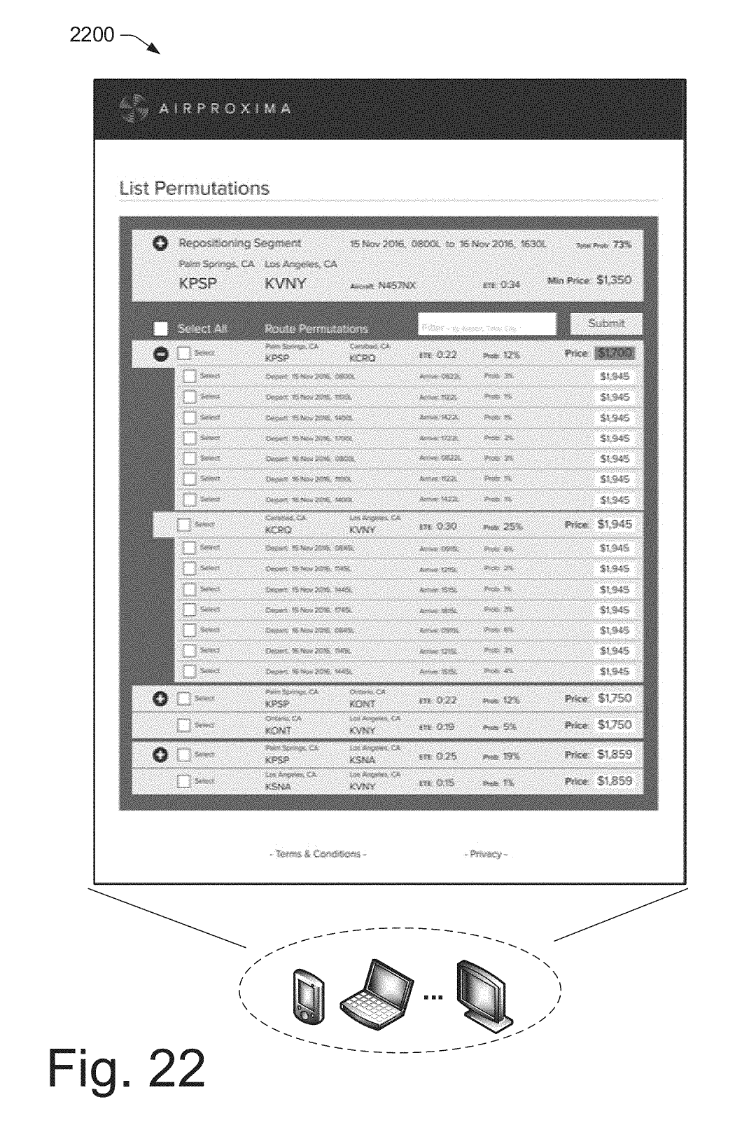

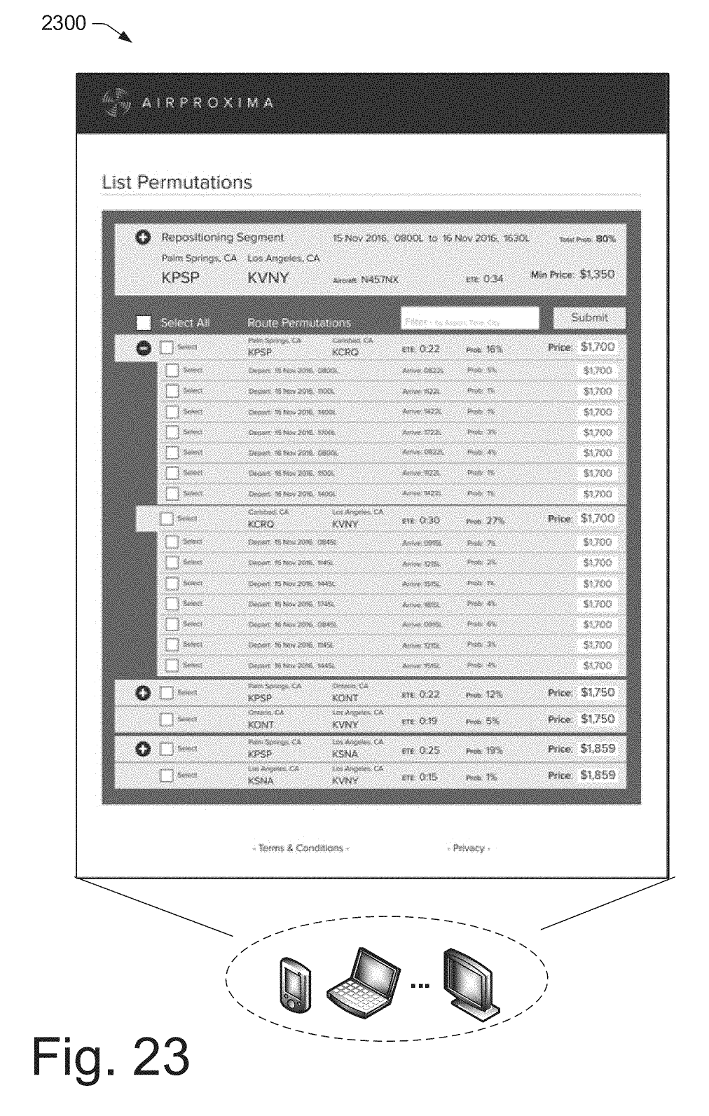

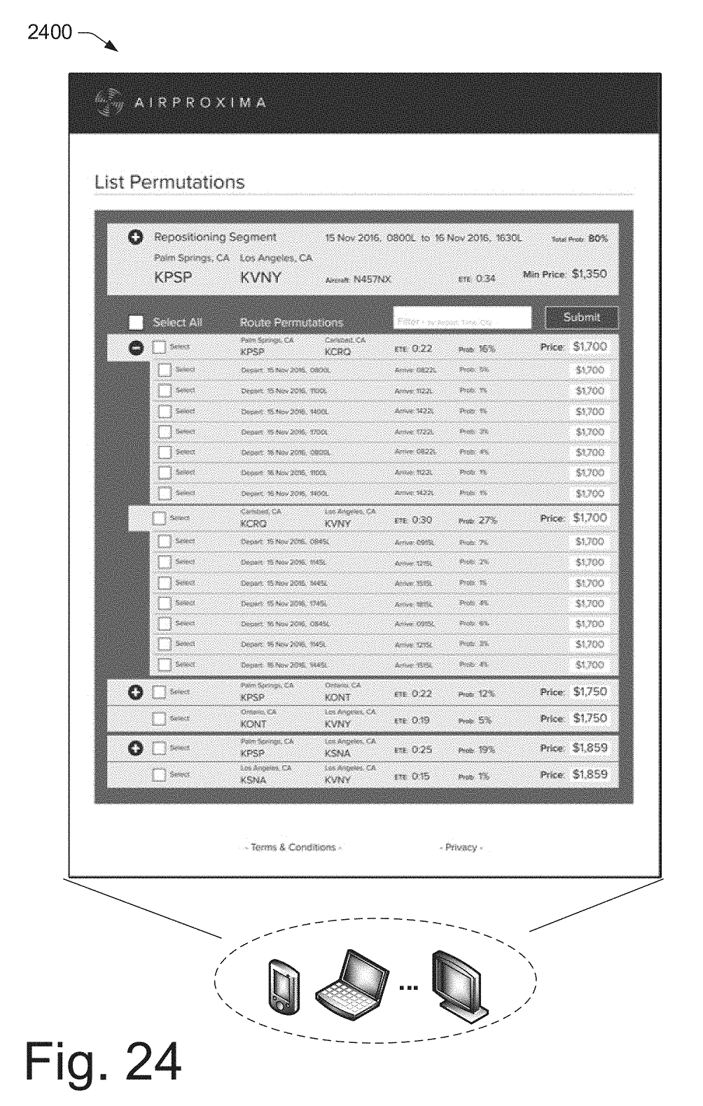

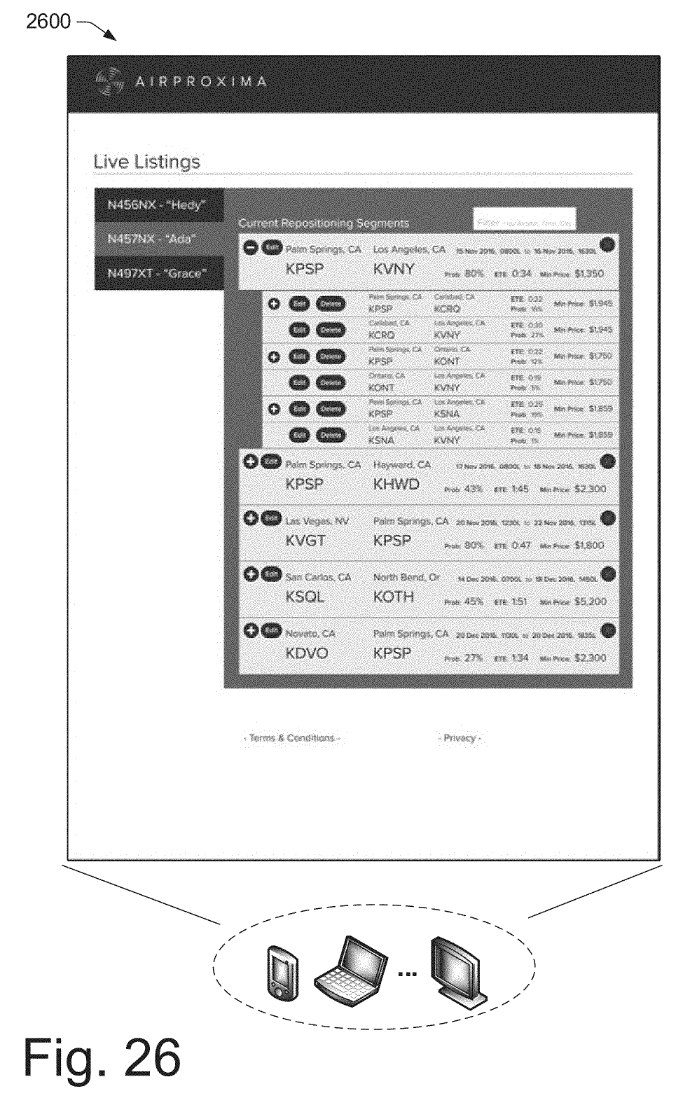

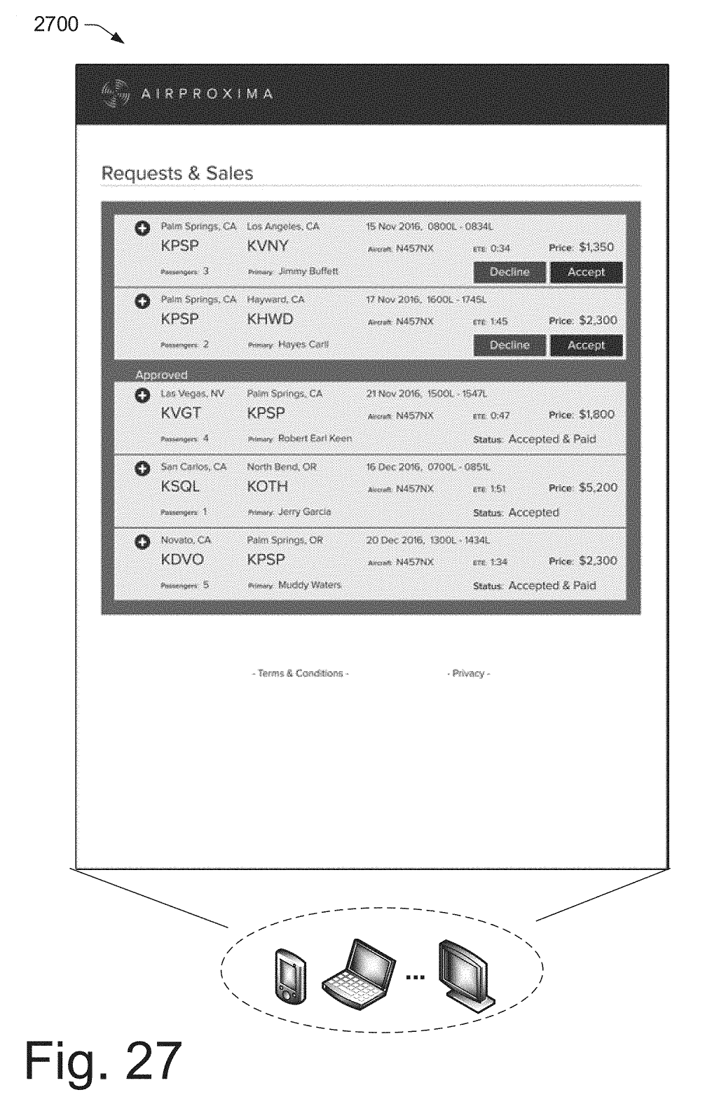

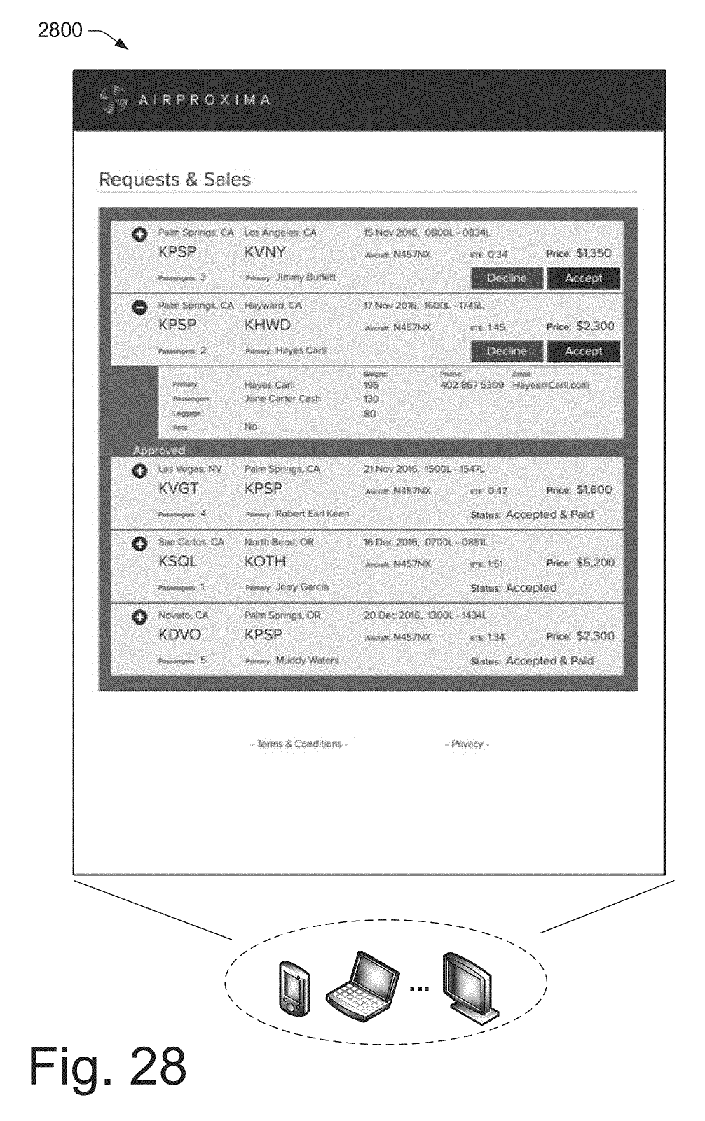

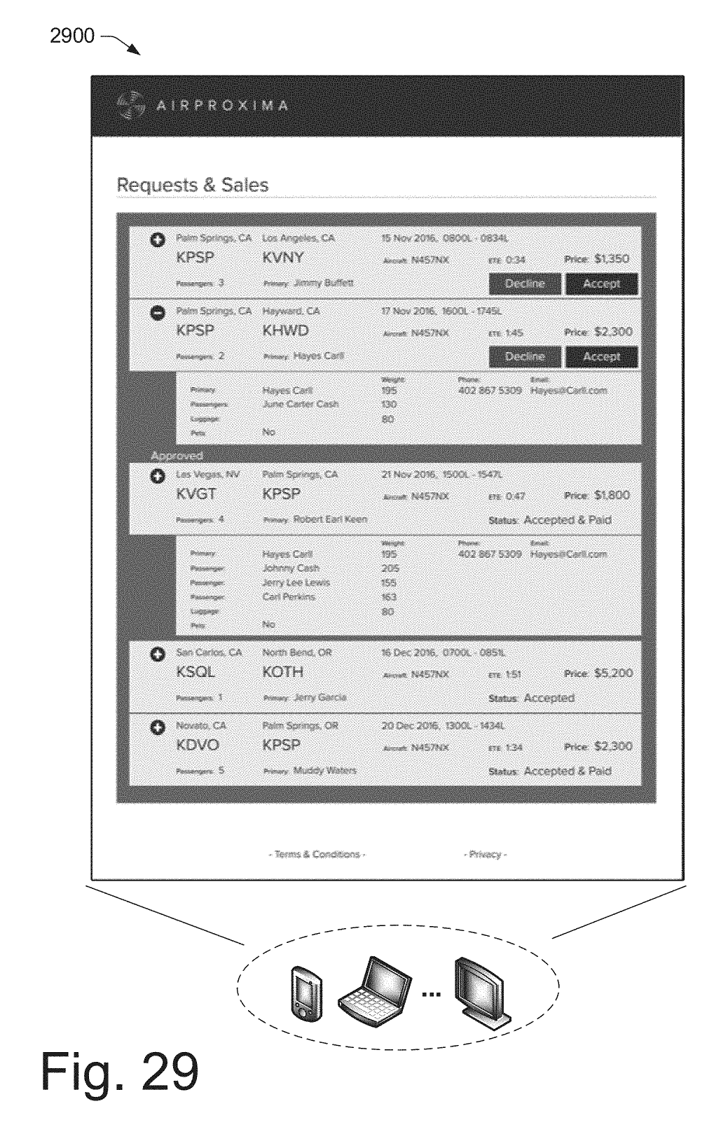

FIGS. 16-58 show illustrative user interfaces. For example, FIGS. 16-30 show an illustrative example where an operator has entered a new flight window. FIG. 16 shows an illustrative user interface 1600. Here, a user “Mr. Anderson” may be an operator seeking to add a flight offering. FIG. 17 shows a user interface 1700 where the user has selected the “Add Repositioning” icon indicating that the user would like to add a repositioning flight to his flight offerings. Here, the flight window has the following parameters Depart: KPSP and Arrive: KVNY with a Min Price: $1,350. Here the Earliest Departure Date & Time: Nov. 15, 2016 0800 (PST) (local airport time) and Latest Arrival Date & Time: Nov. 16, 2016 1630 (PST) (local airport time), where an hourly rate of this plane: $1450.

For illustrative purposes, assume operator removed all other airport options except for KPSP, KVNY, KPSP with KPSP>KHWD. Here the ETE: 0:34, $1,350 (from minimum These are “flight options” and appropriate departure times that Date&Time window.

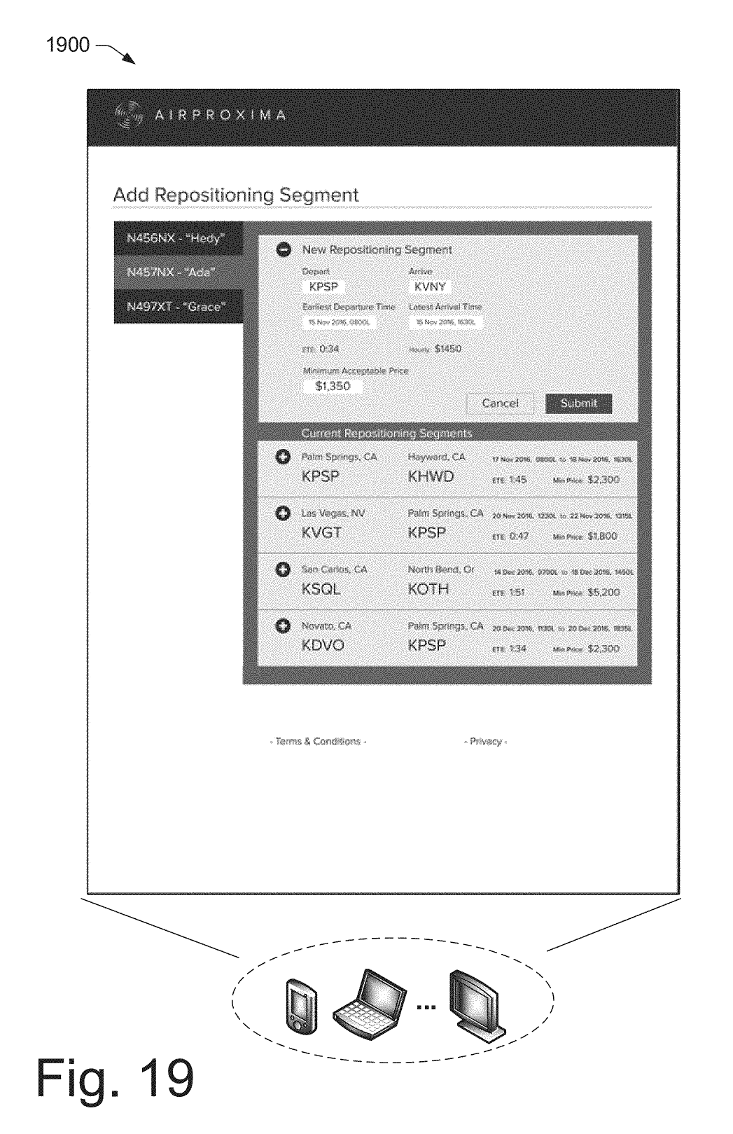

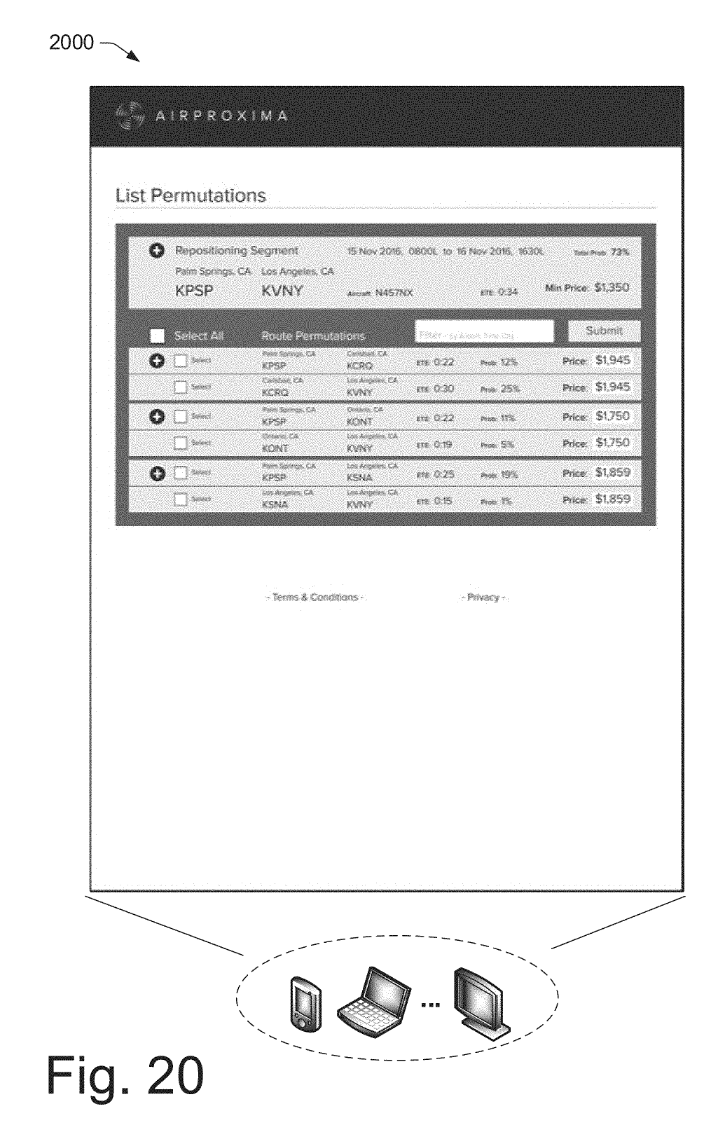

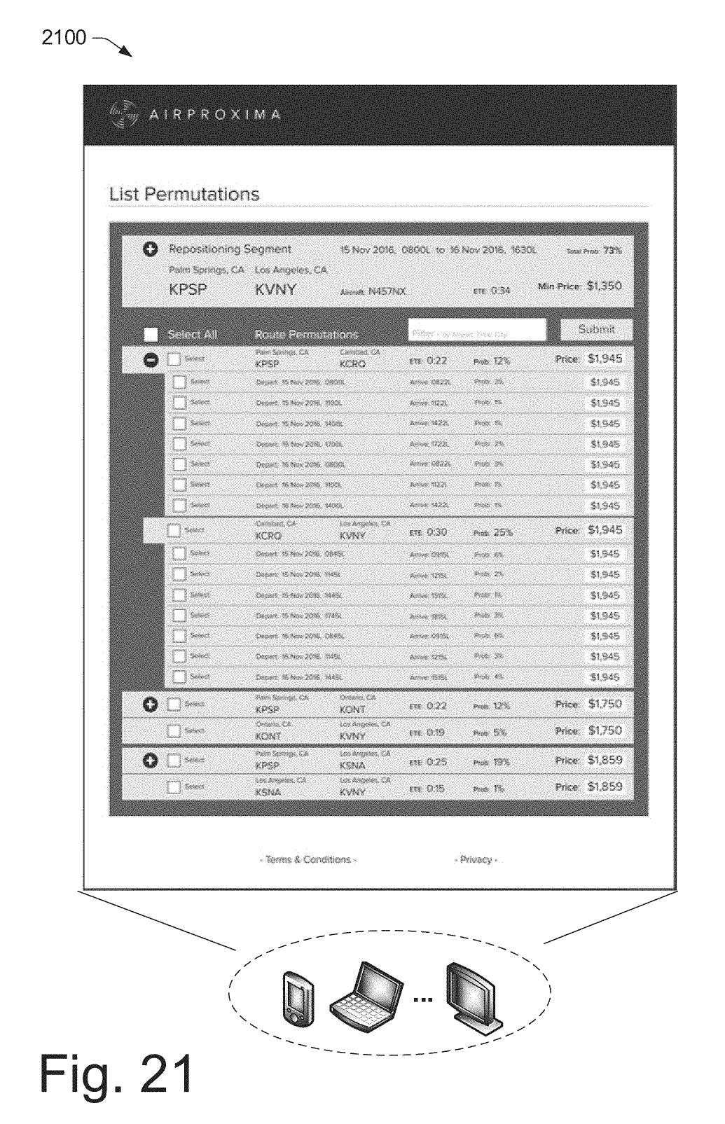

For the flight from KPSP to KHWD, FIG. 19 shows an ETE of 1:45 and Min Price of $2,300. FIG. 20. These are “flight options” and should have appropriate departure times that fit in the Date&Time window. FIG. 21 shows route permutations. FIG. 19. 3 flight options are possible to be marketed (ignoring date & time). The flight from KPSP to KHWD has an ETE of 1:45 and a Min. Price of $2300. Flight KVGT to KPSP has an ETE of 0:47 and a Min. Price of $1800. The Flight from KSQL to KOTH has an ETE of 1:51 and a Min Price of $5200.

FIG. 20-24 show UI's illustrating permutations, demonstrating that the operator may select a specific price in their search. For example, the operator chooses “$1700” and views the results. Various embodiments contemplate three types of permutations for the operator to choose, for example, route-based permutations, price-based permutations, time-based permutations, or combinations thereof.

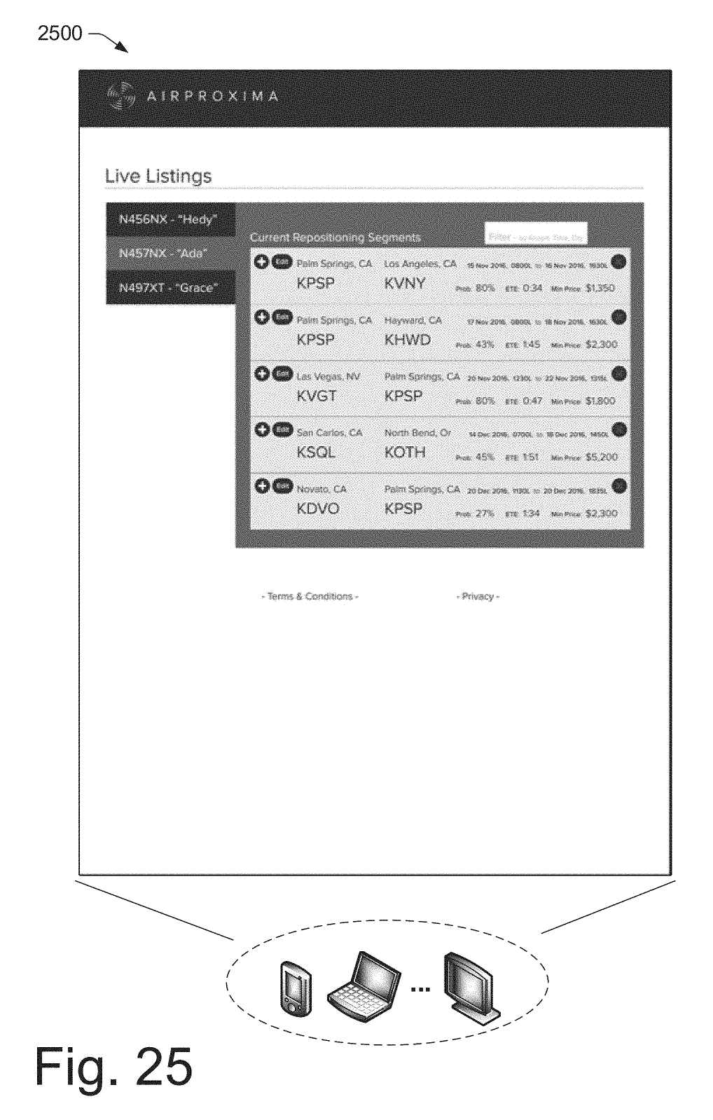

FIG. 25 shows illustrative live listings that are an option that the operator can view and “Decline” or “Accept” flights from various airports while viewing a detailed drop down tab with information about the flight.

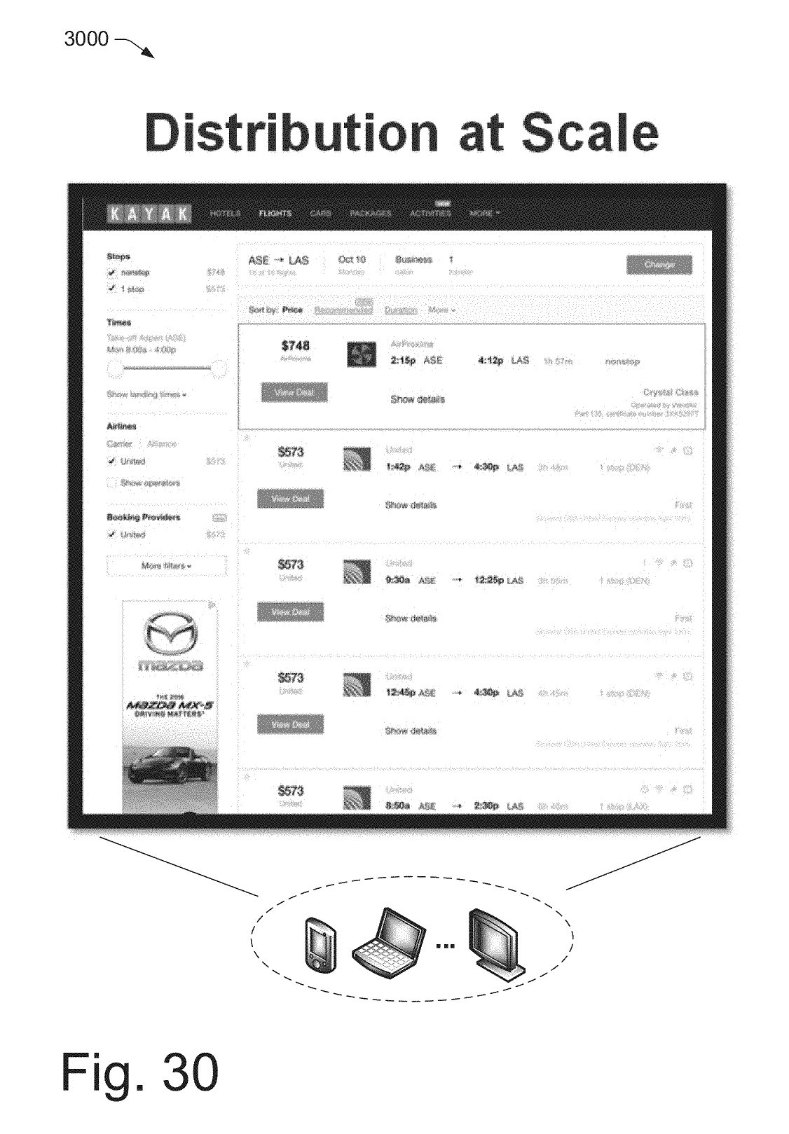

FIG. 30 shows an illustrative UI 3000 with a flight listed on an illustrative OTA.

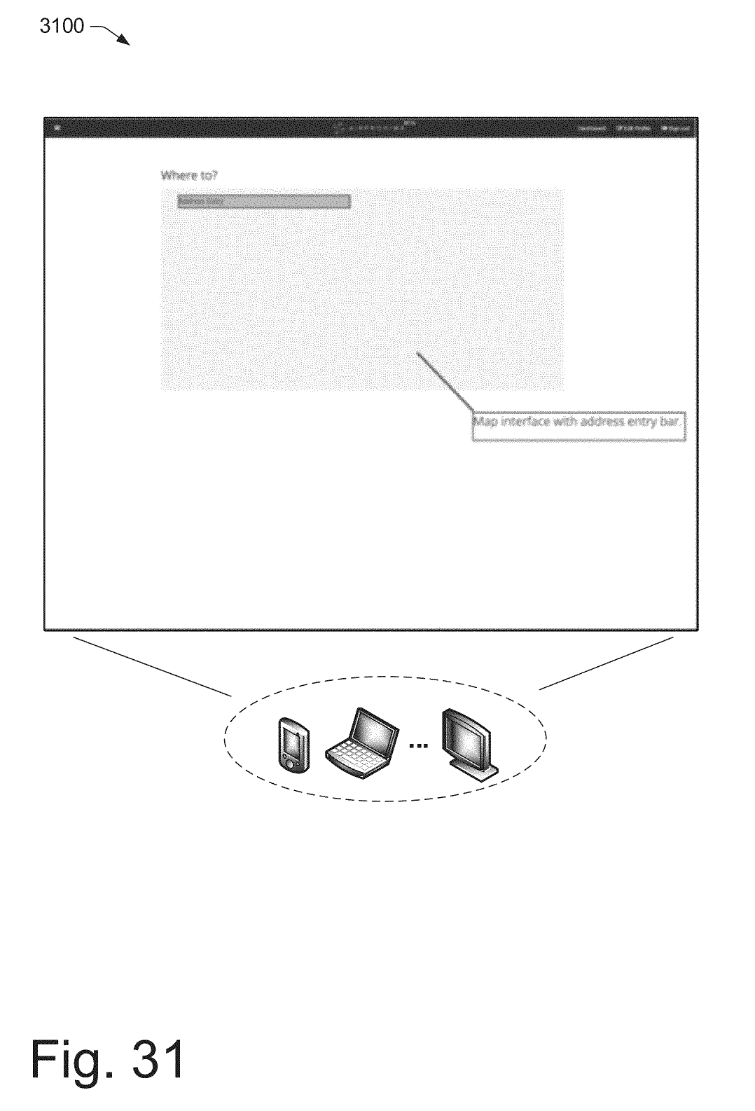

FIGS. 31-58 show illustrative UI's where users are able to interact with an illustrative system. For example, FIG. 31 shows an illustrative UI 3100 where the user can input an address of a destination.

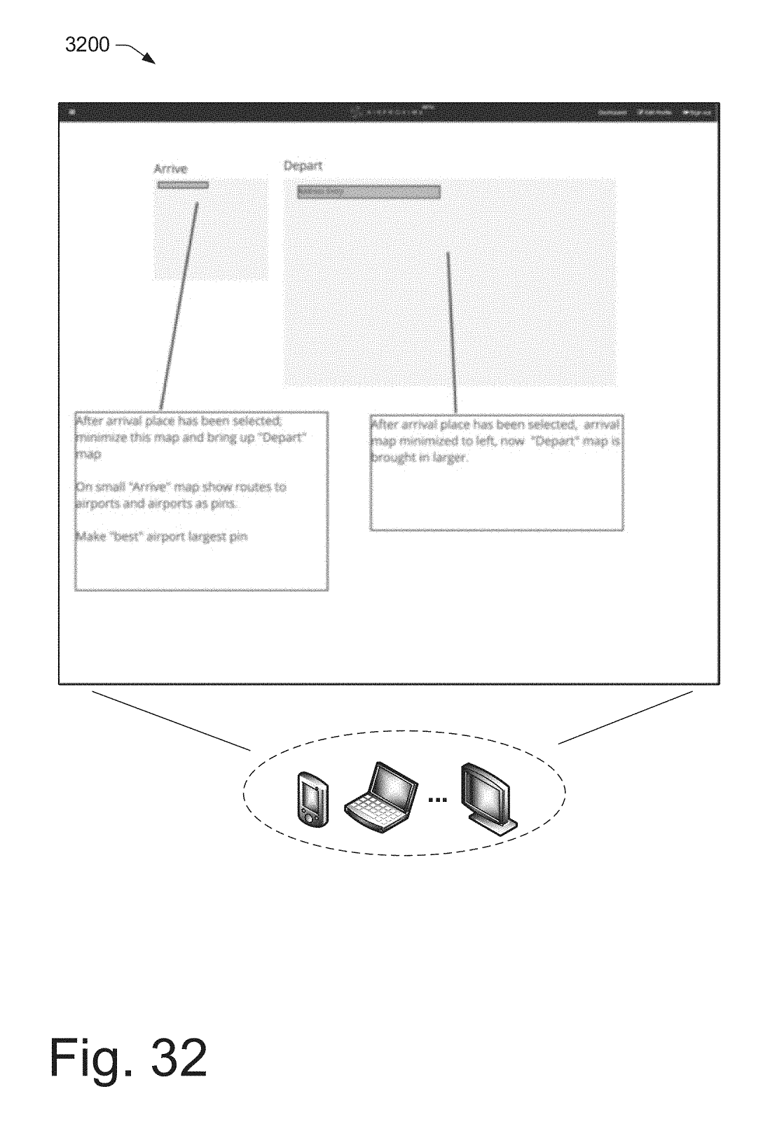

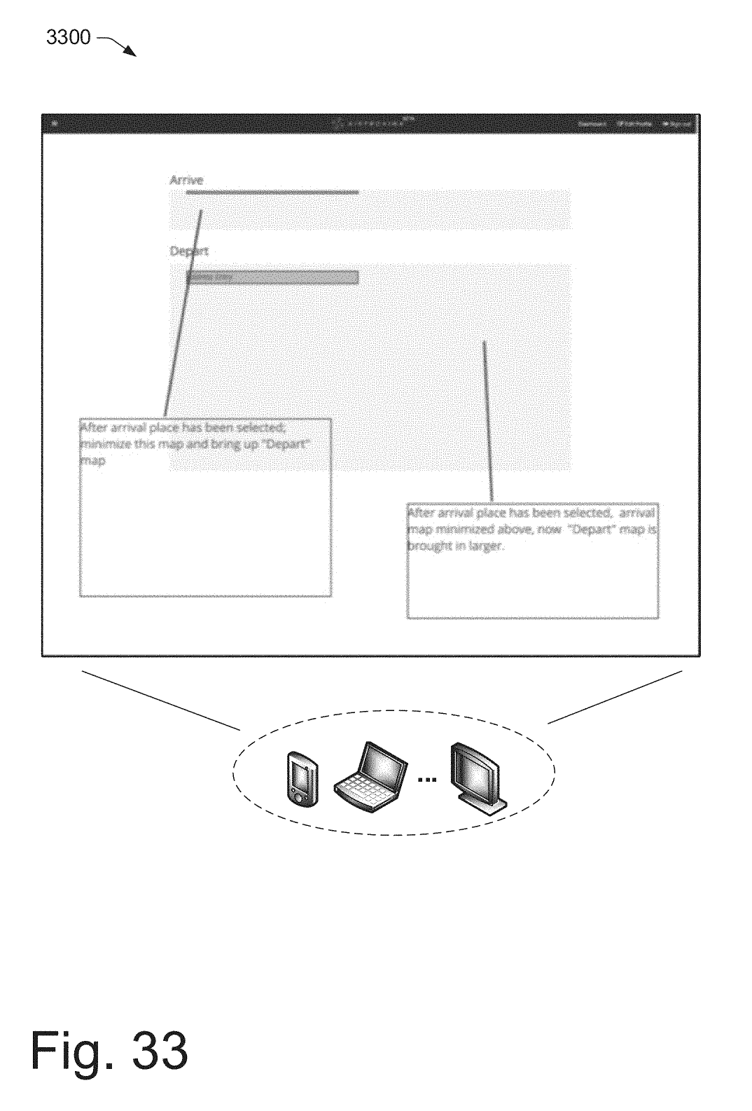

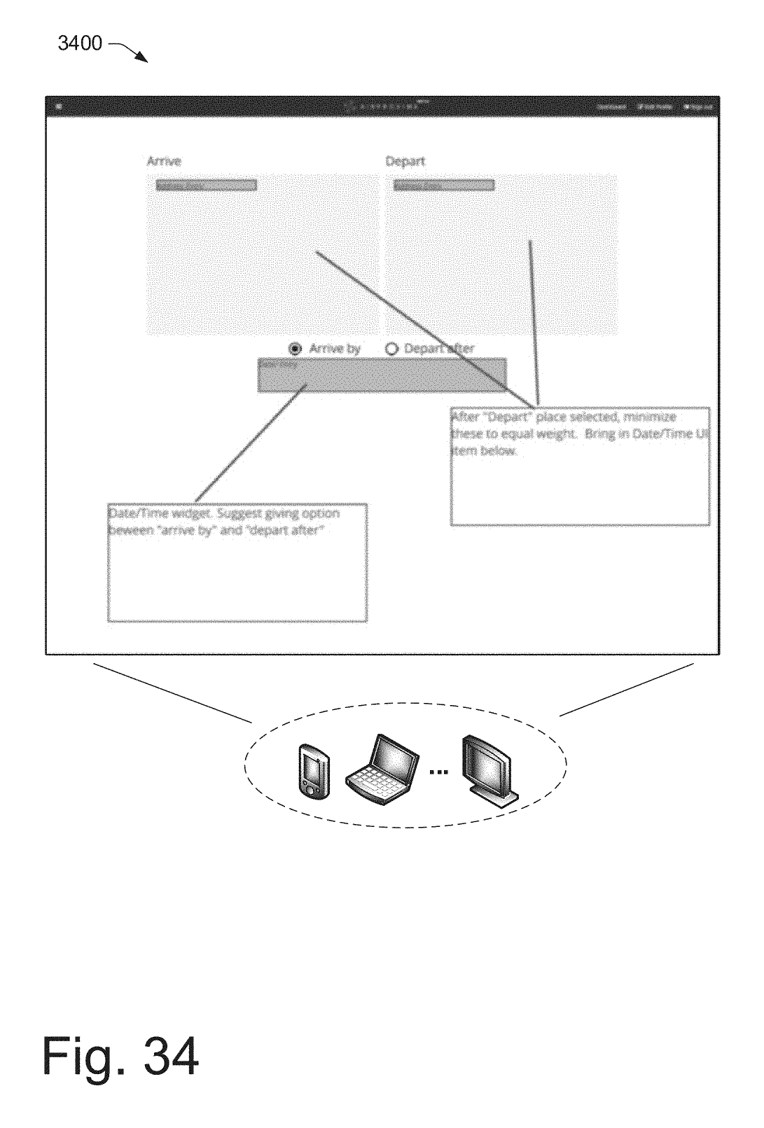

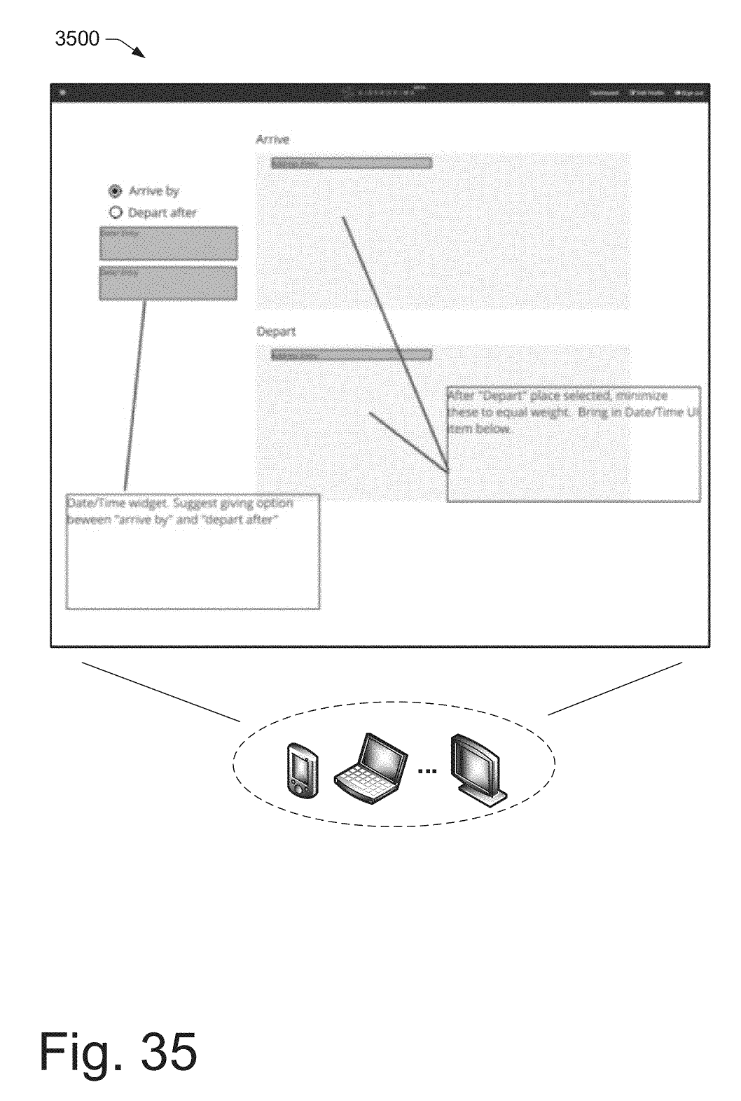

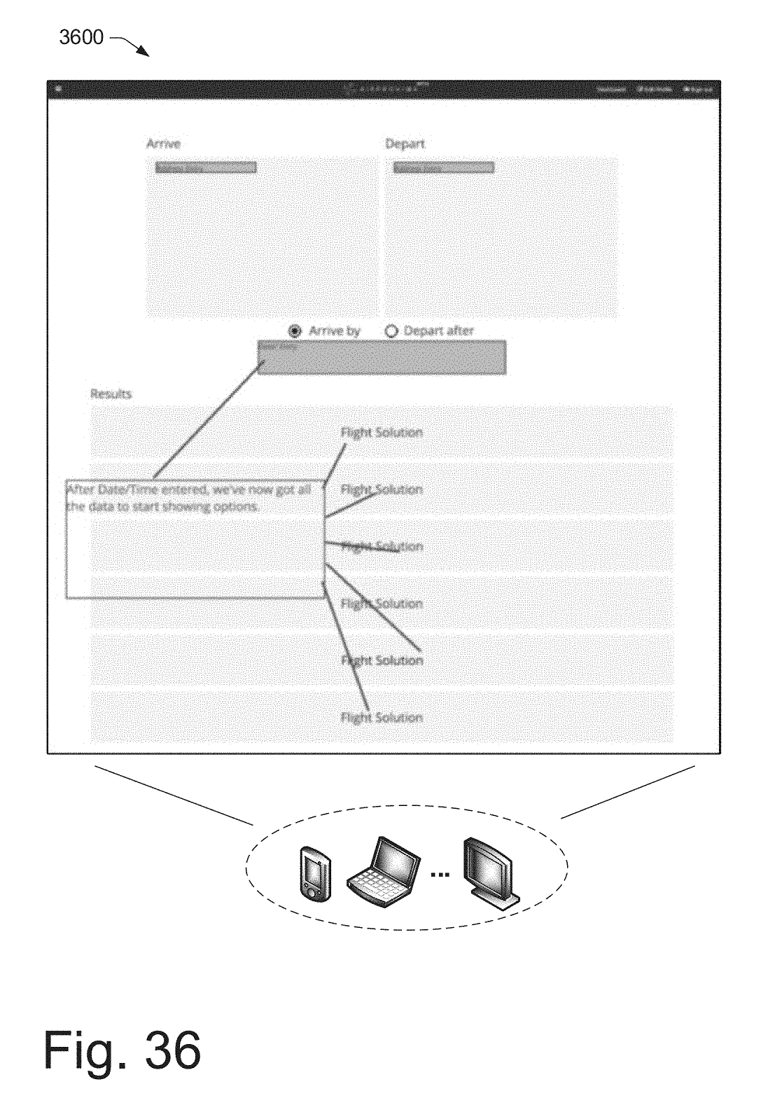

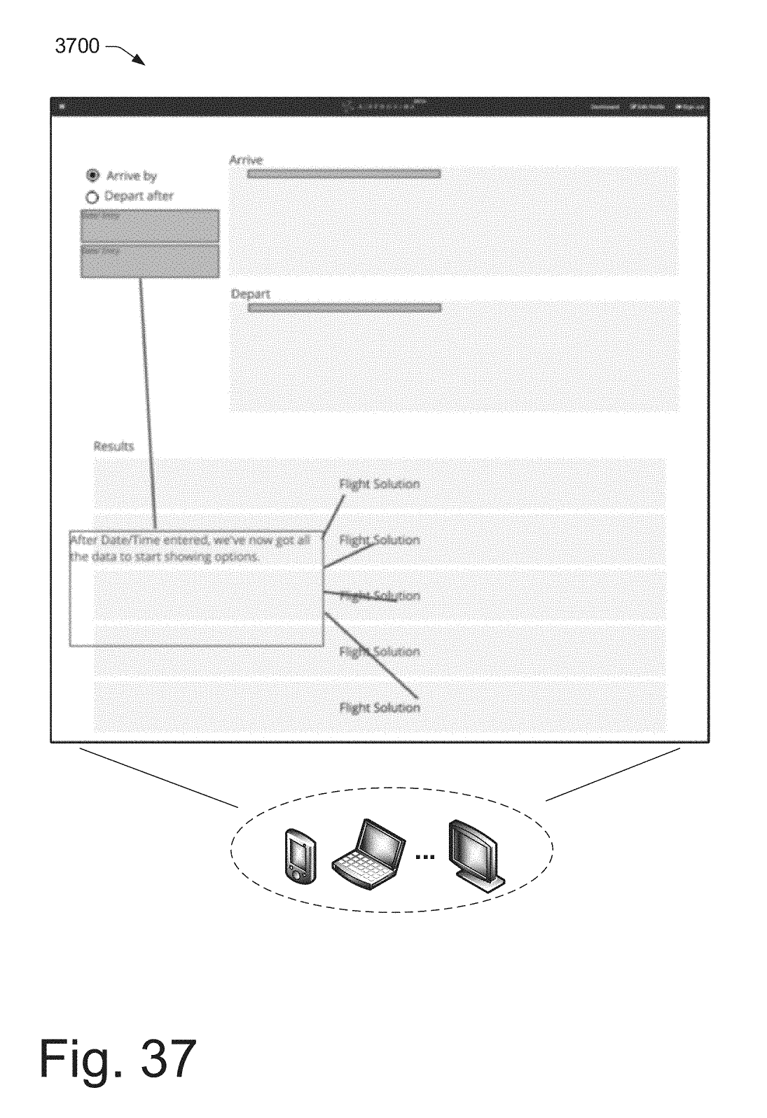

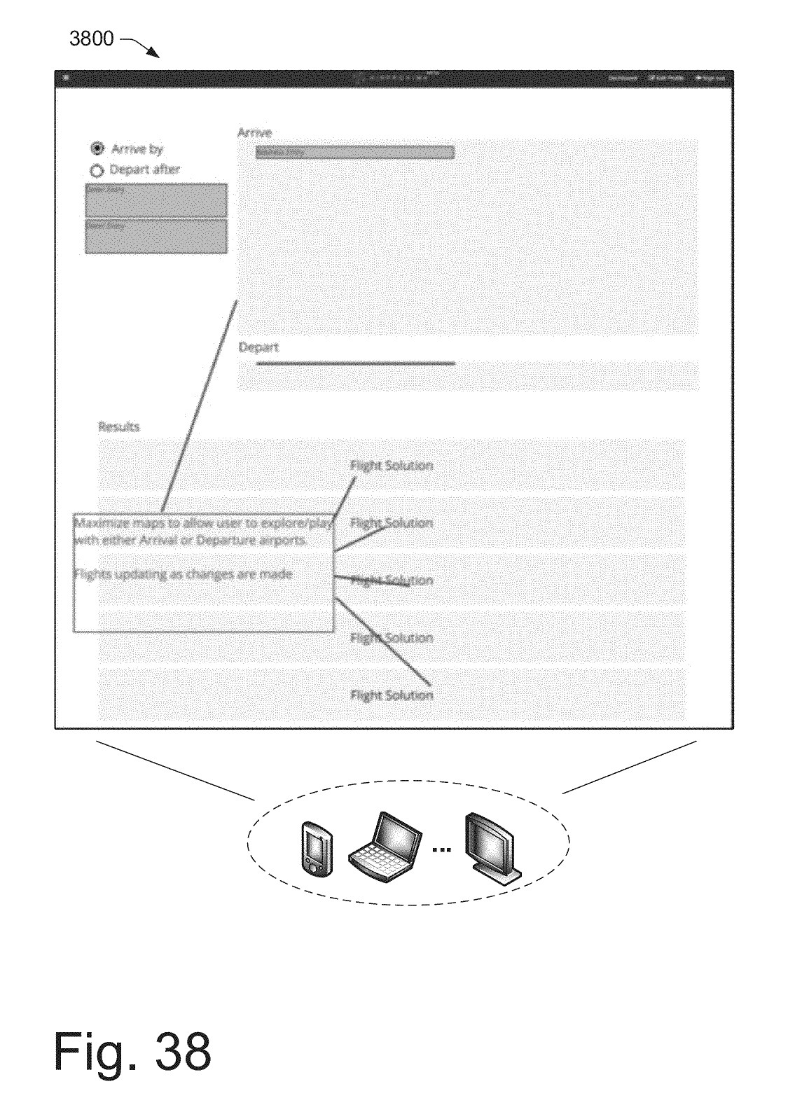

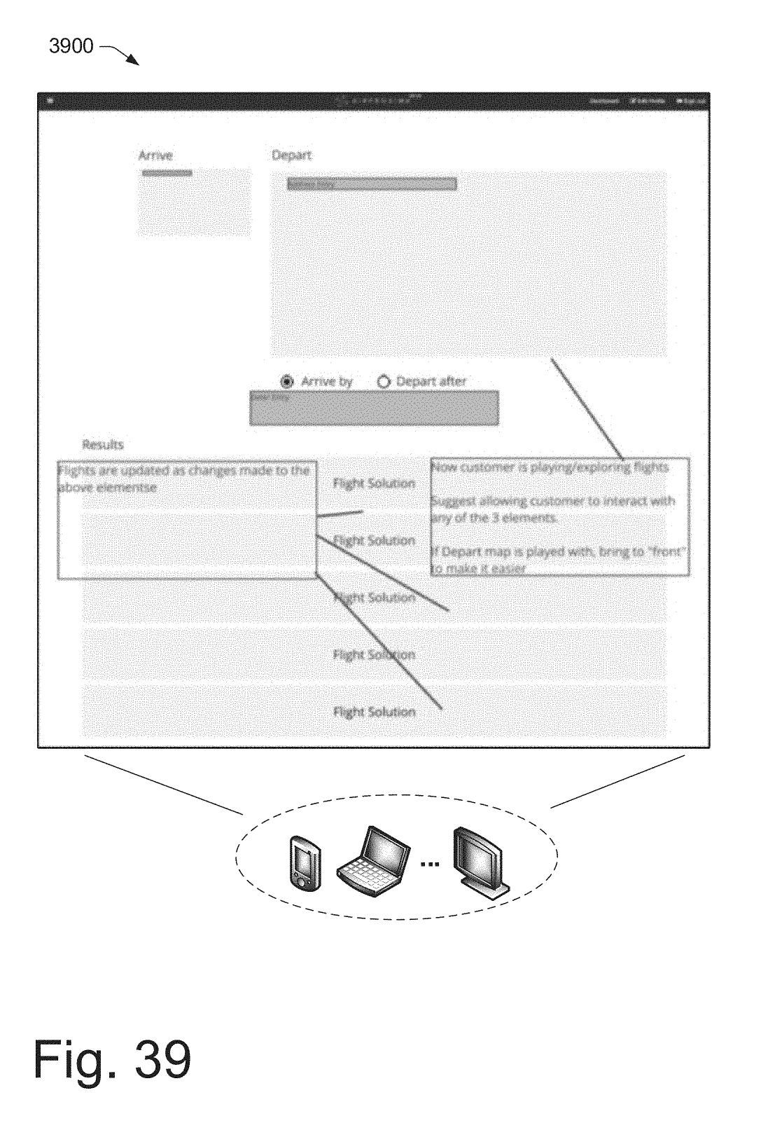

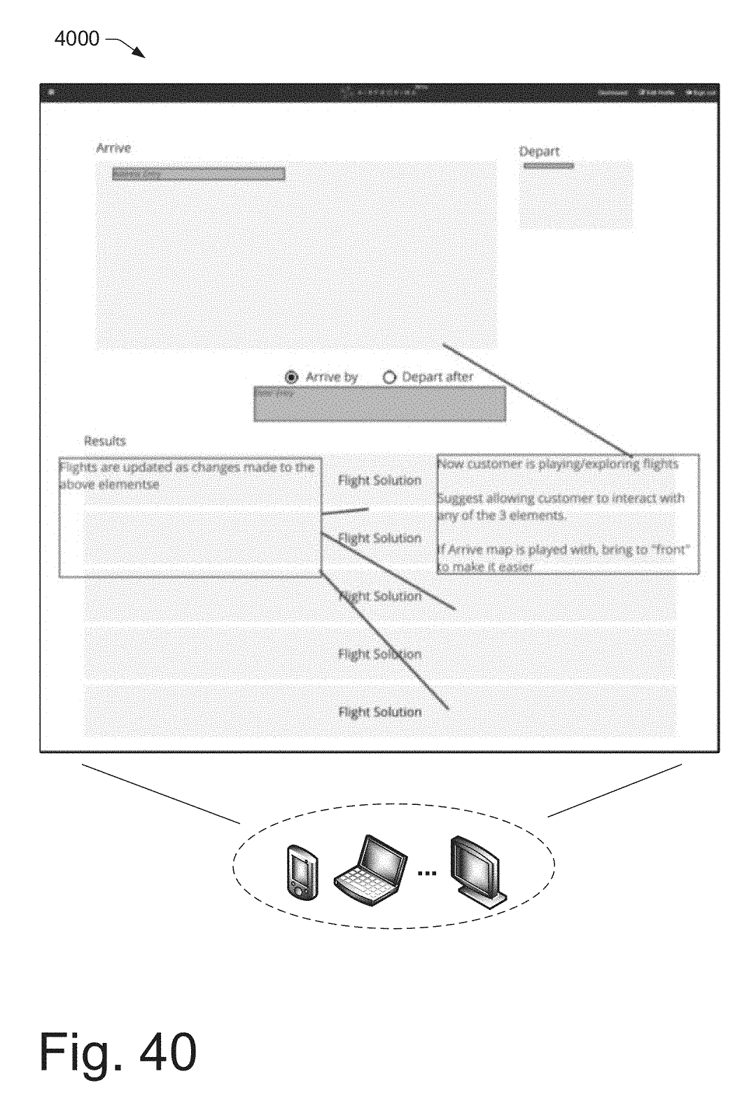

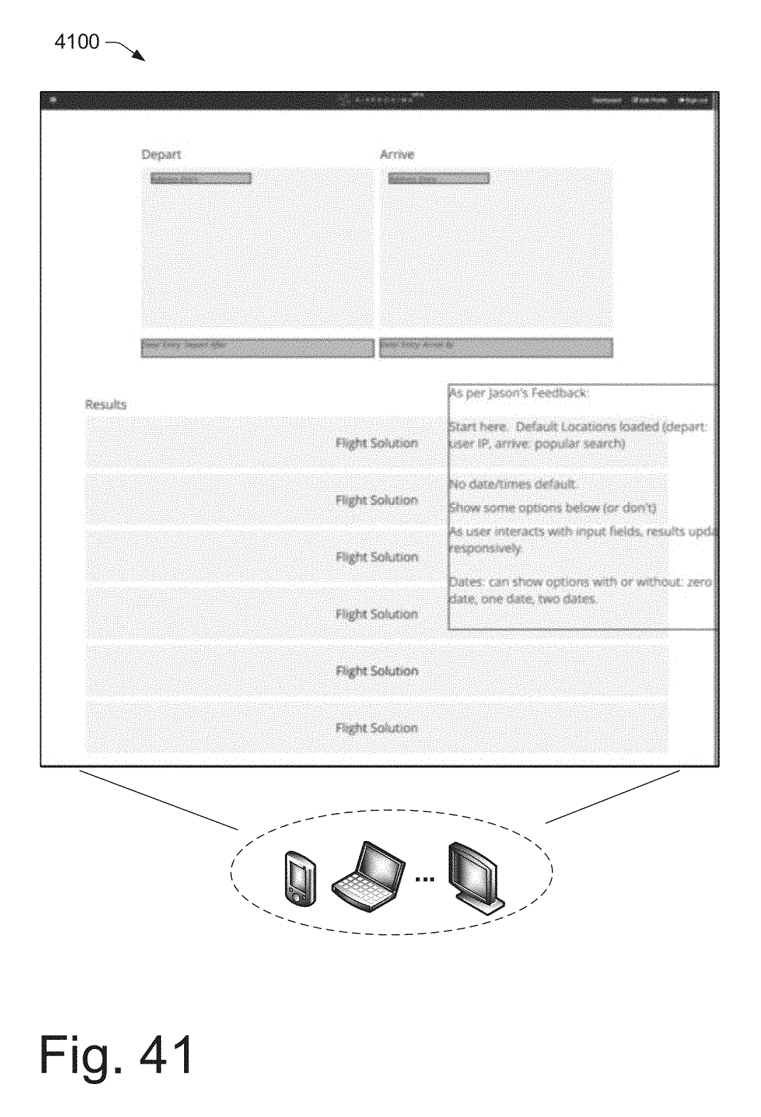

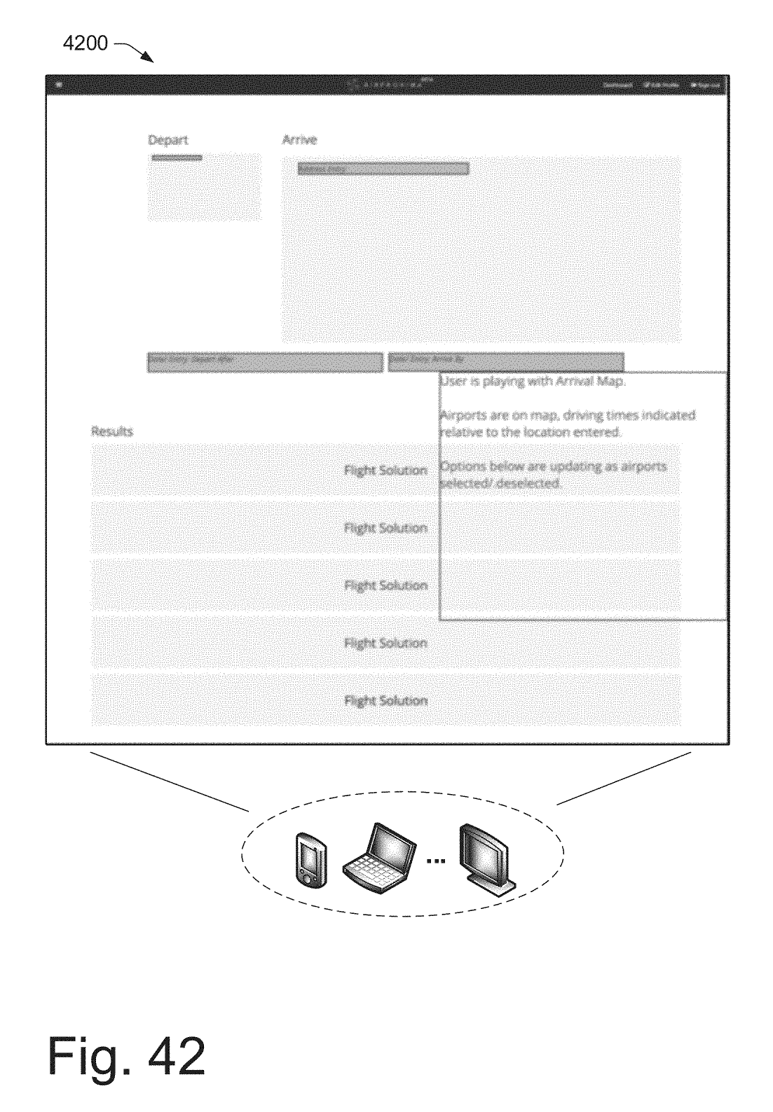

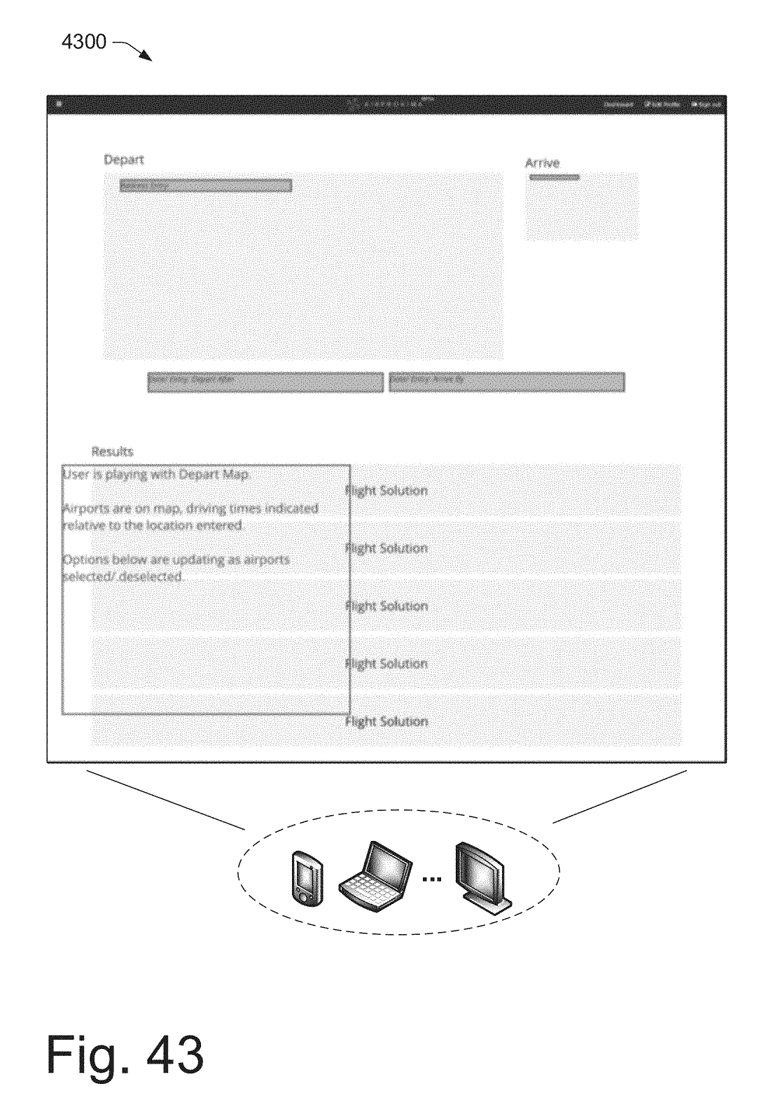

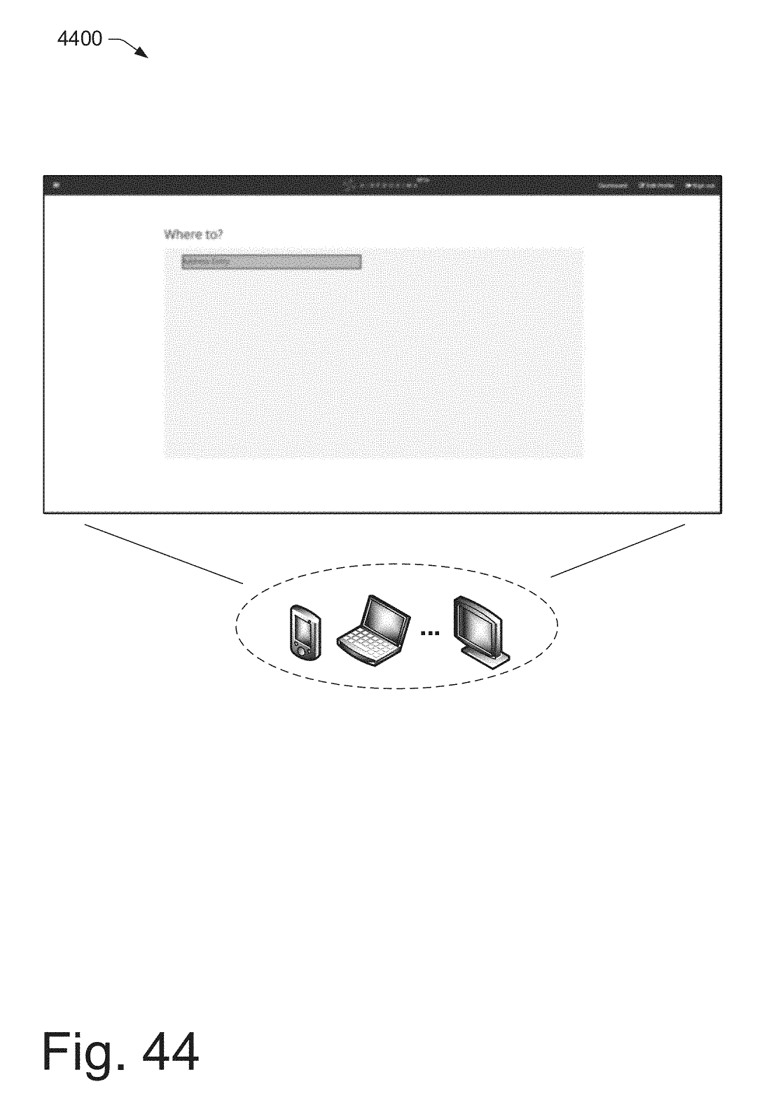

FIG. 32 shows an illustrative UI 3200 for the user to select “Depart” and “Arrive” locations. FIG. 33 shows an illustrative UI 3300 for the user to view maps of “Depart” and “Arrive” locations. FIG. 34 shows an illustrative UI 3400 where the user can select “Arrive by” and “Depart after” Date/Time. FIG. 35 shows an illustrative UI 3500 where the user can view their previous selections of 3100, 3200, 3300 and 3400. FIG. 36 shows an illustrative UI 3600 where the user can view “Flight Solutions.” FIG. 37 shows an illustrative UI 3700 where the user can view “Flight Solutions” with a different screen arrangement. FIG. 38 shows an illustrative UI 3800 where the user can maximize “Flight Solution” options to explore “Arrival” airports. FIG. 39 shows an illustrative UI 3900 where the user can maximize “Flight Solution” options to explore “Departure” airports. FIG. 40 shows an illustrative UI 4000 with the updated results of the user's changes. FIG. 41 shows an illustrative UI 4100 with default settings option. FIG. 42 shows an illustrative UI 4200 where the user has selected the “Arrival” map or airports and driving times relative to locations. FIG. 43 shows an illustrative UI 4300 where the user has selected the “Depart” map or airports and driving times relative to locations. FIG. 44 shows an illustrative UI 4400 where the user can input a new destination.

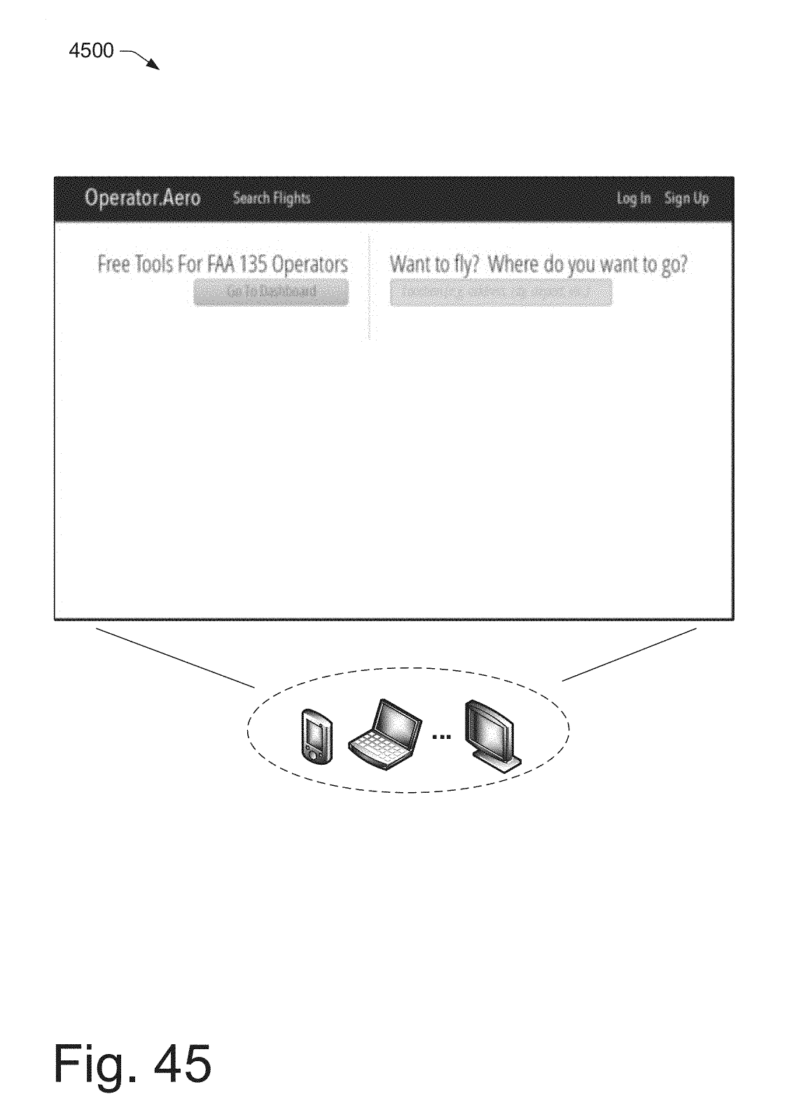

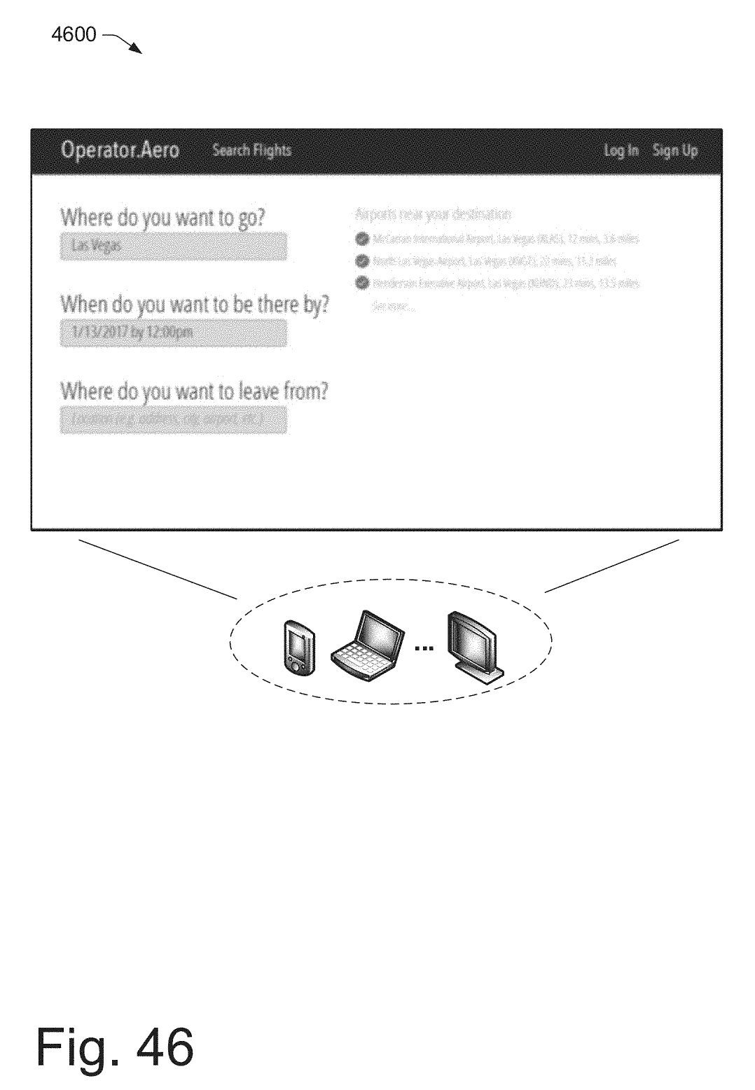

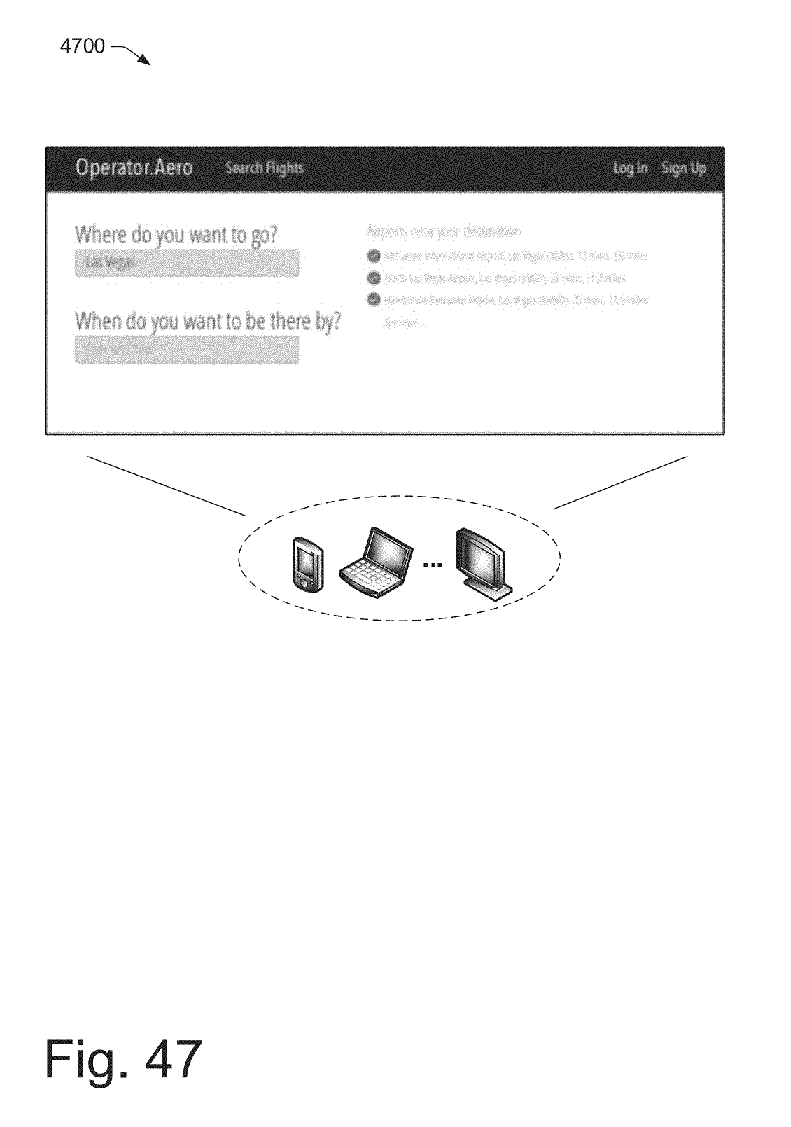

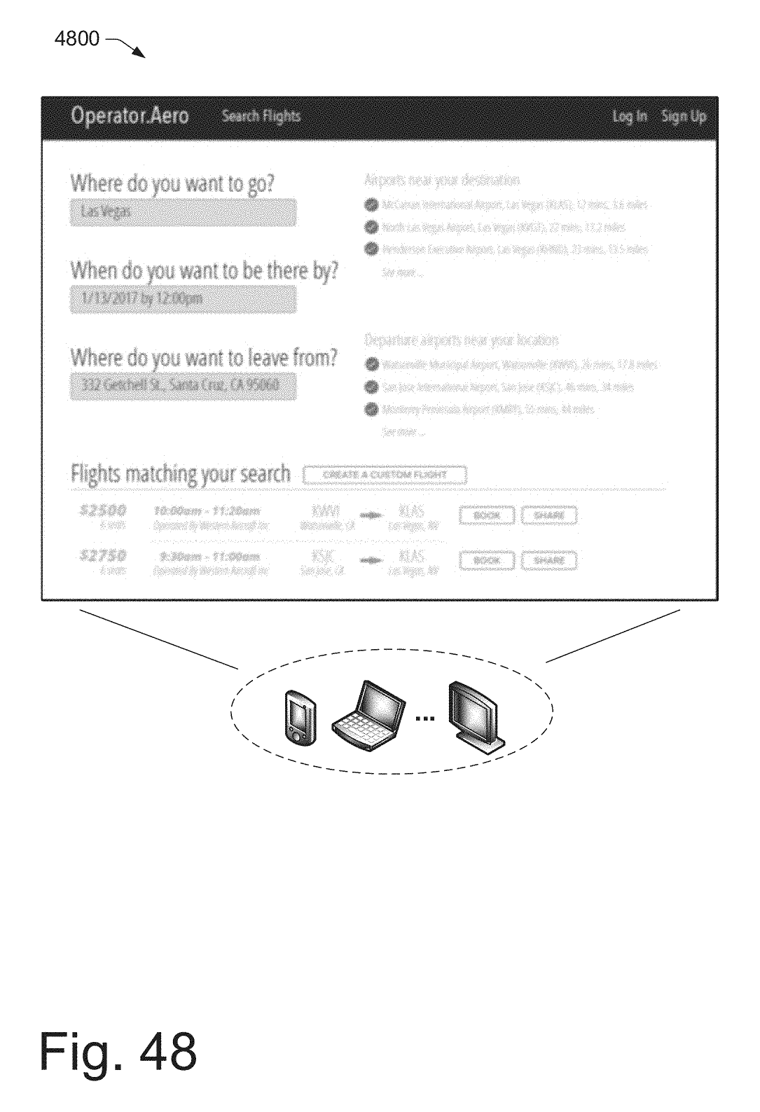

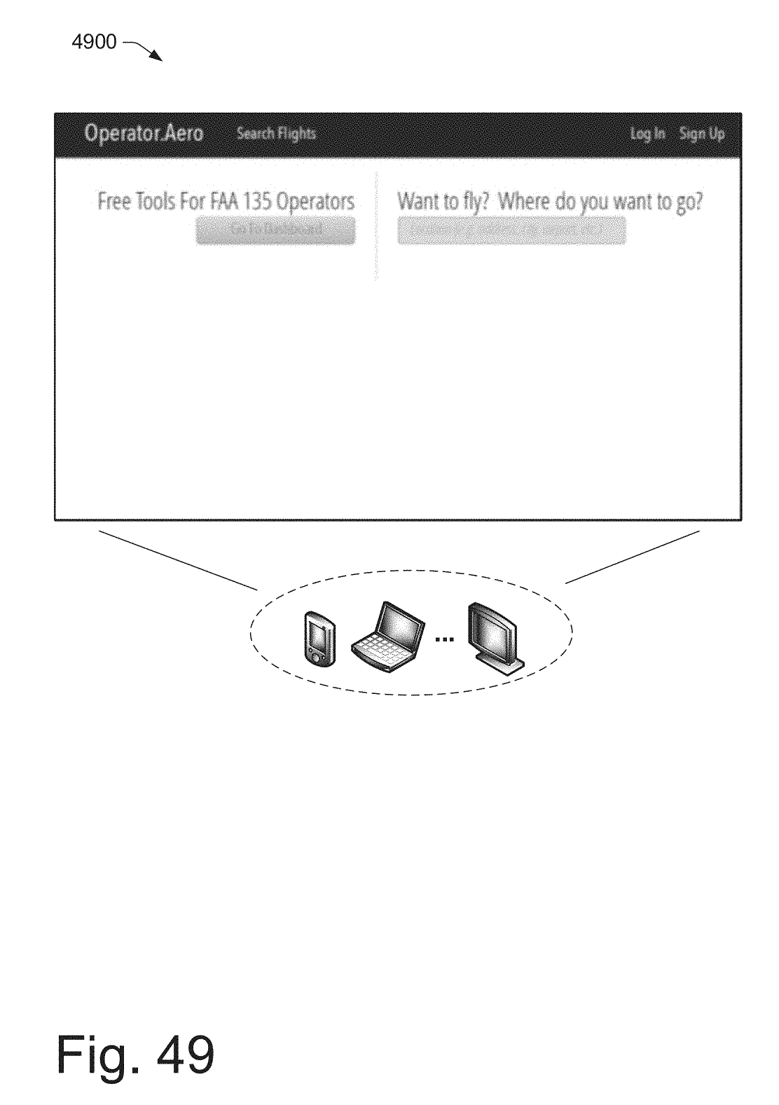

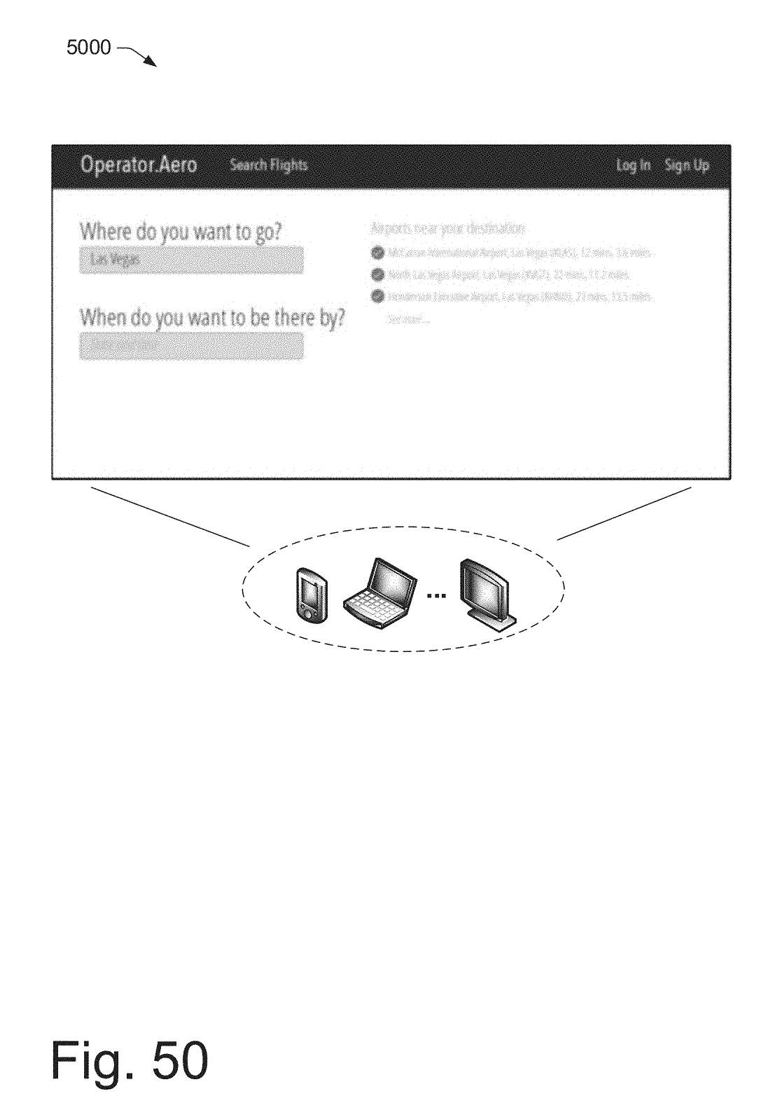

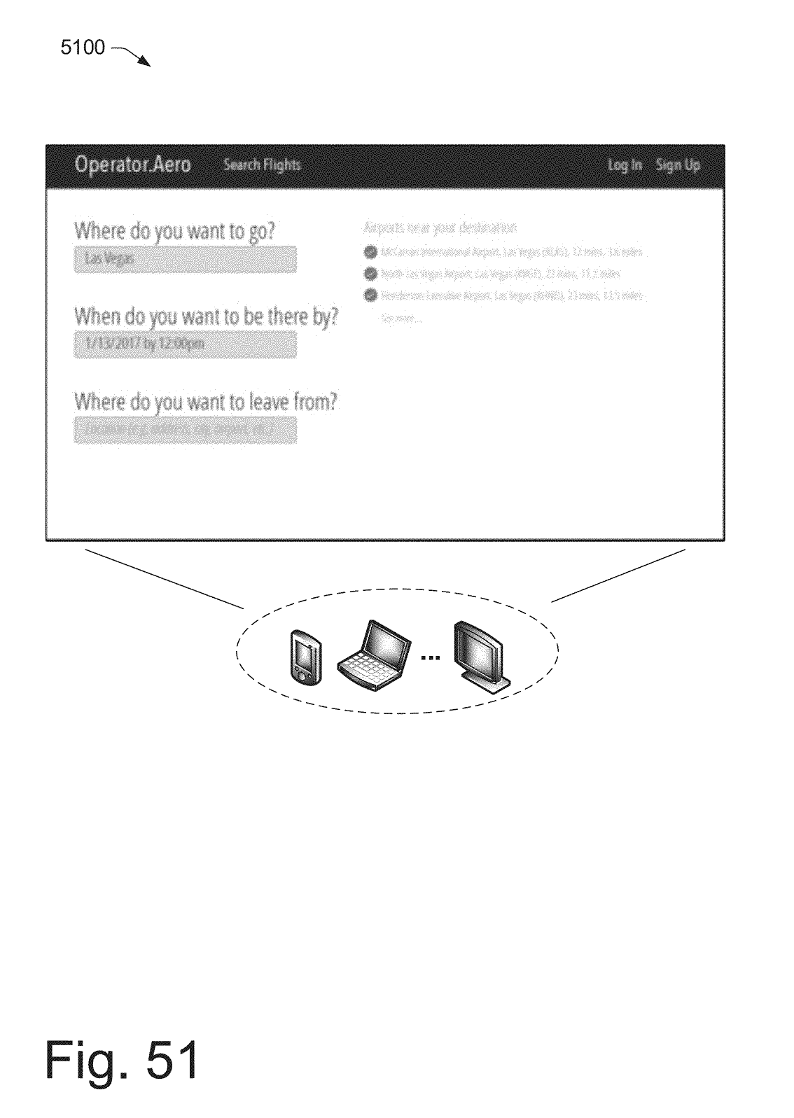

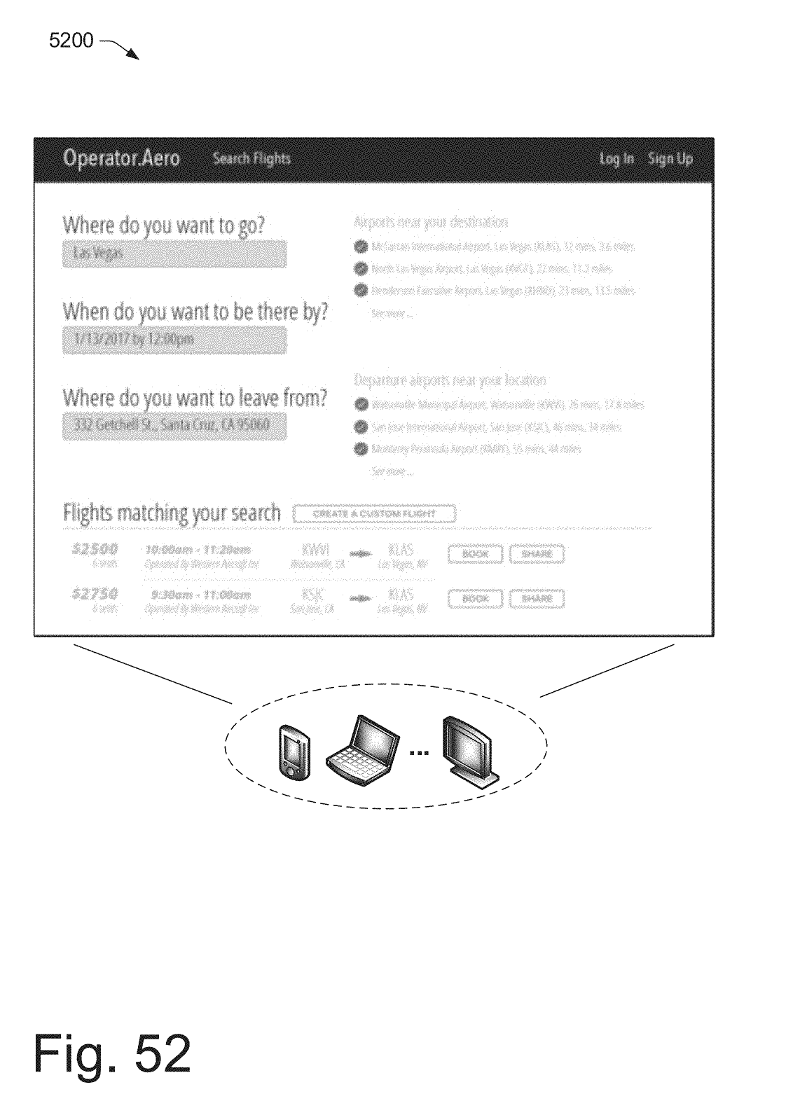

FIG. 45 shows an illustrative UI 4500 where user can “Go to Dashboard”, input a destination, Log In or Sign Up at “Operator.Aero.” FIG. 46 shows an illustrative UI 4600 where the user views results from an inputted destination and arrival time. FIG. 47 shows an illustrative UI 4700 where the user views results from an inputted destination. FIG. 48 shows an illustrative UI 4800 where the user can view flights from an inputted destination, arrival time and departure location. FIG. 49 shows an illustrative UI 4900 where user can “Go to Dashboard”, input a destination, Log In or Sign Up at “Operator.Aero.” FIG. 50 shows an illustrative UI 5000 where the user views results from an inputted destination. FIG. 51 shows an illustrative UI 5100 where the user views results from an inputted destination and arrival time. FIG. 52 shows an illustrative UI 5200 where the user can view flights from an inputted destination, arrival time and departure location.

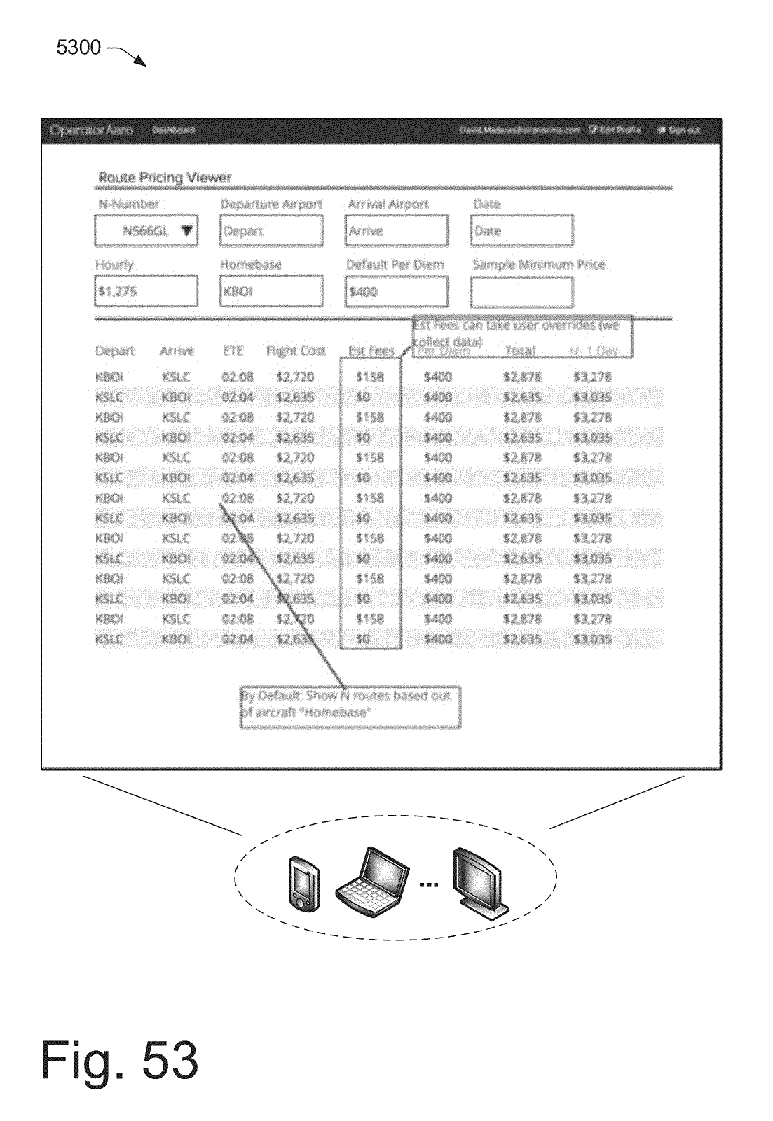

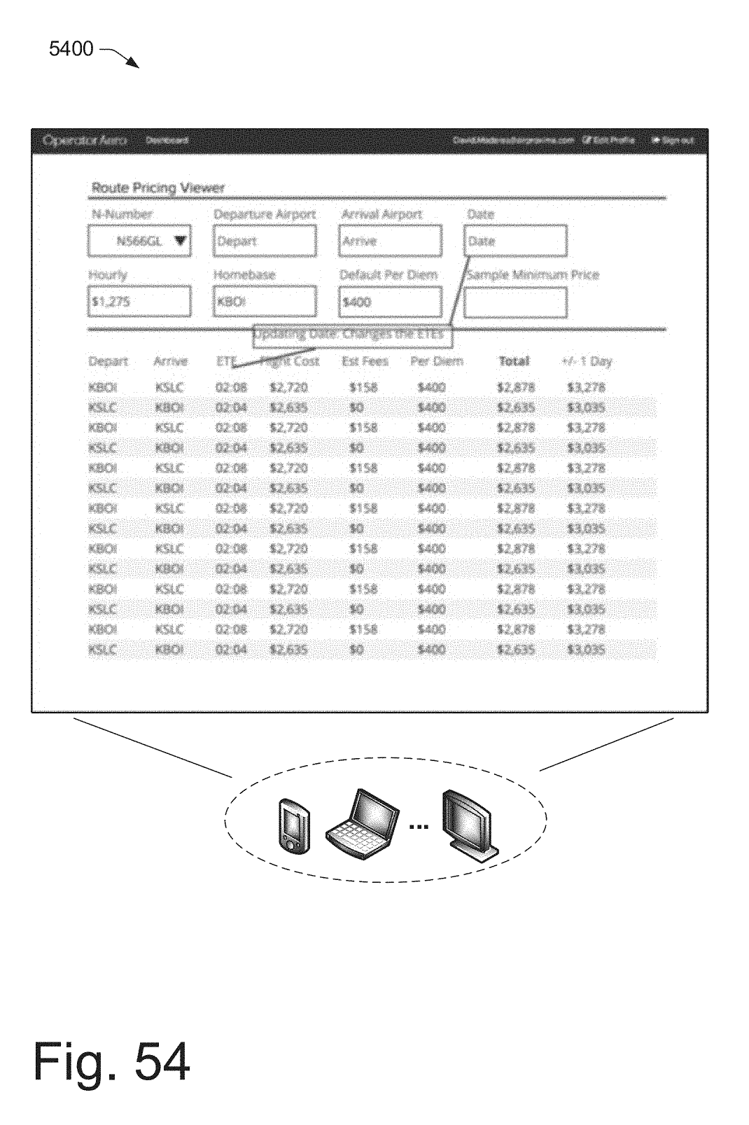

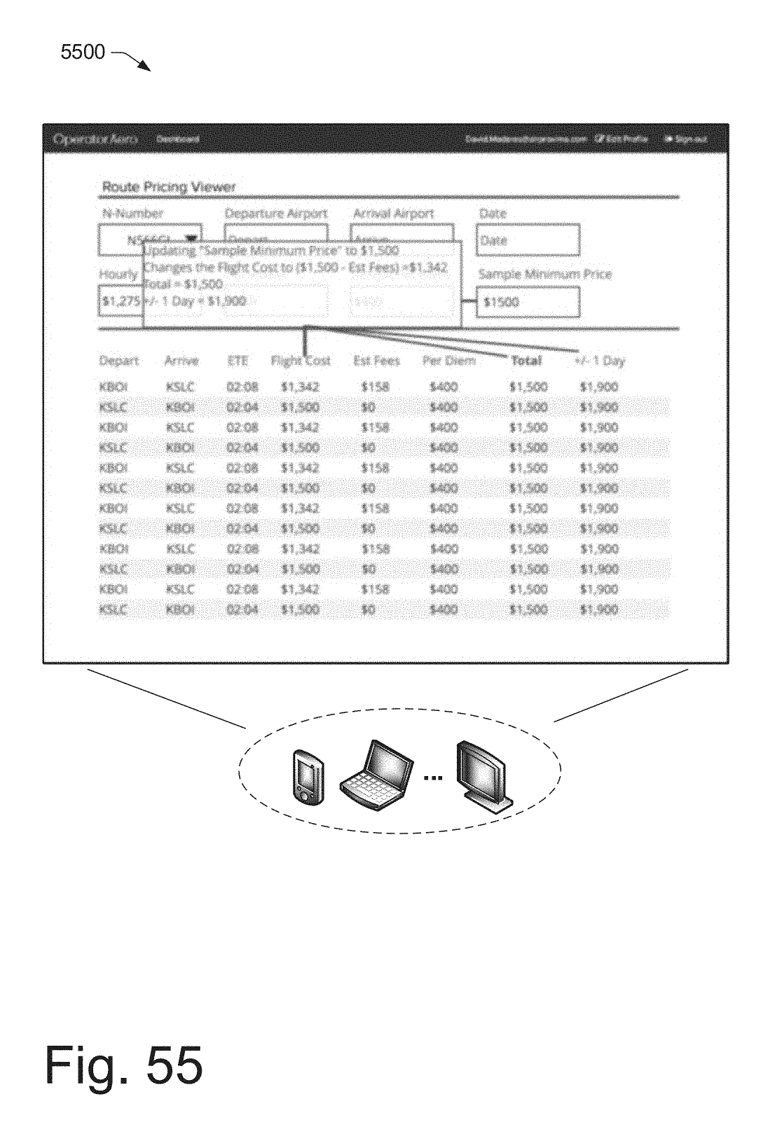

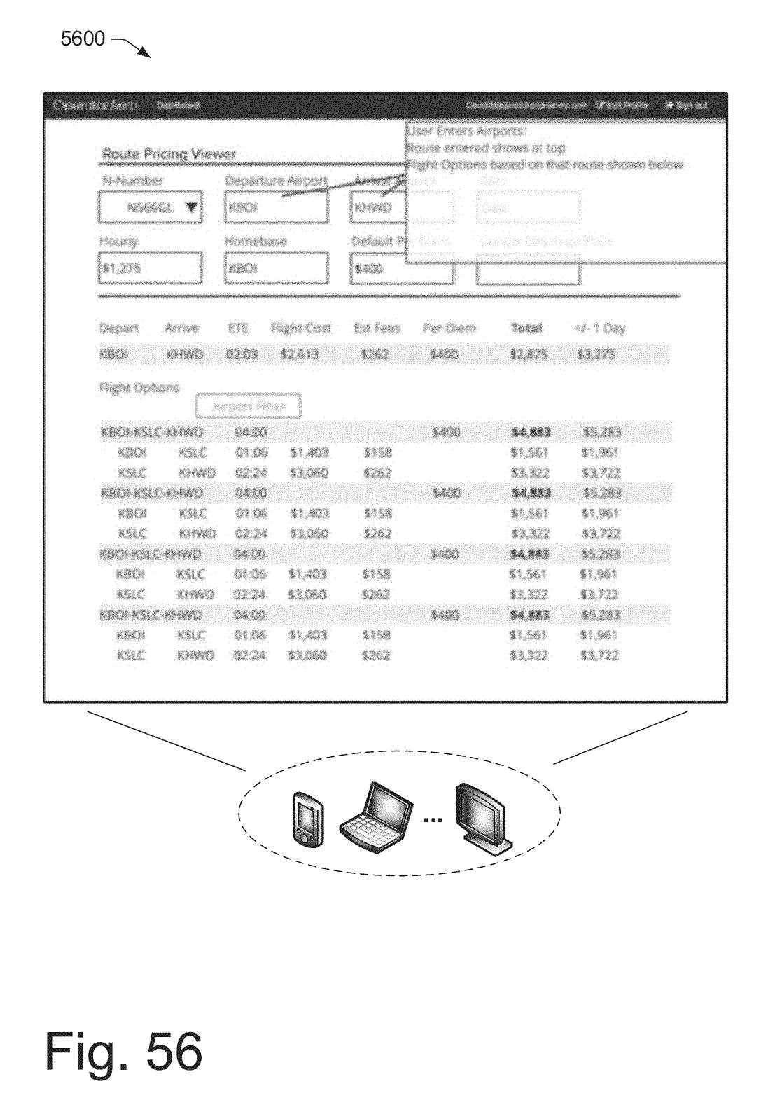

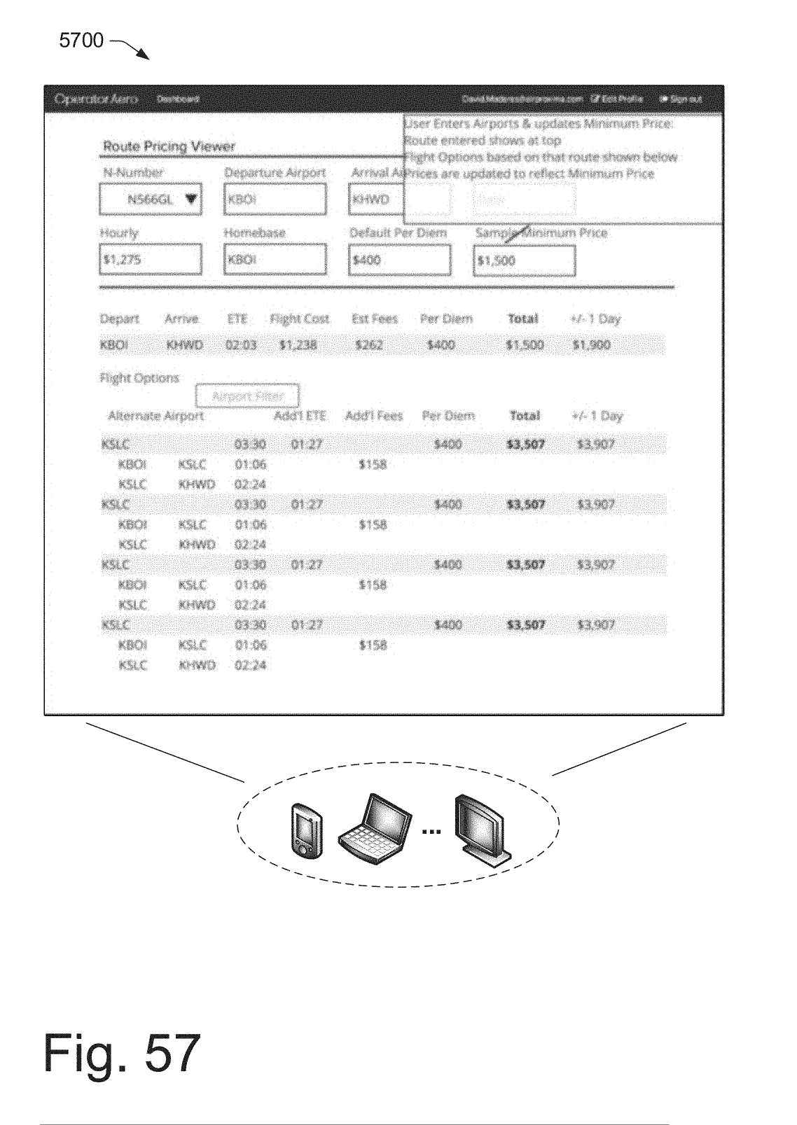

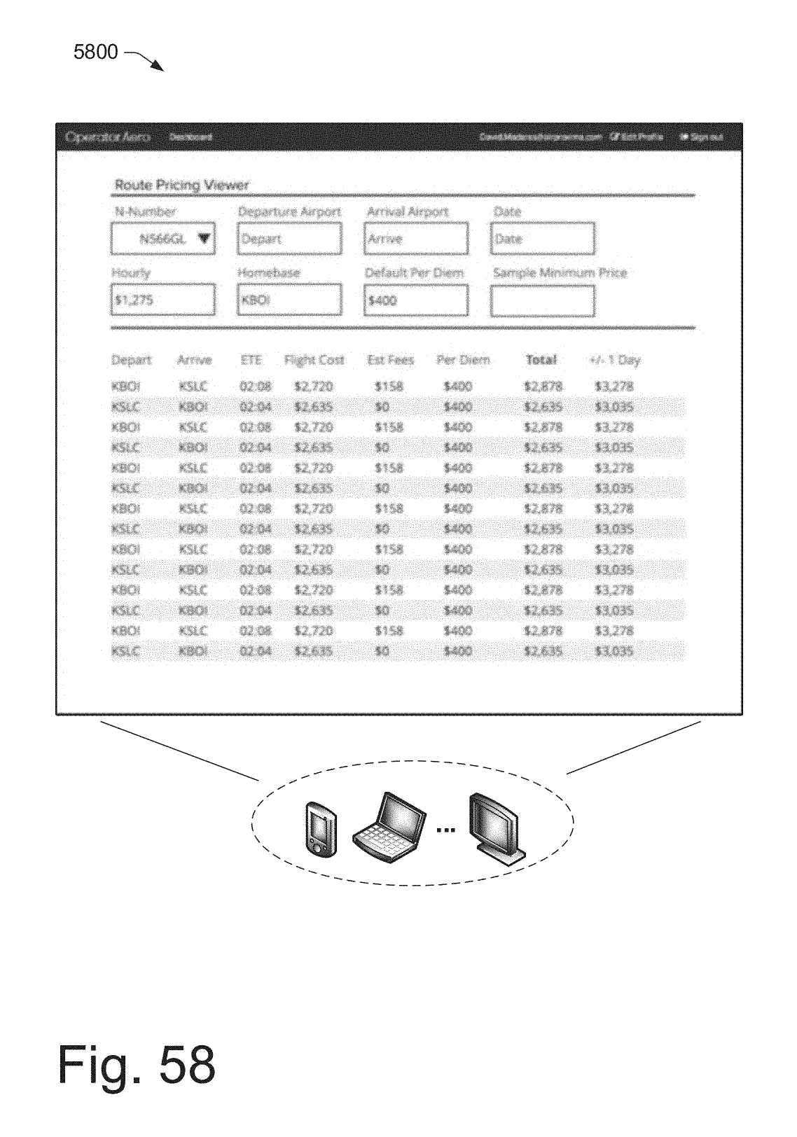

FIGS. 53-58 show an illustrative UI allowing interaction with an illustrative route pricing viewer. For example, FIG. 53 shows an illustrative UI 5300 for the user selected “Dashboard” of the “Route Pricing Viewer” in default mode. FIG. 54 shows an illustrative UI 5400 where the user views results after updating the date. FIG. 55 shows an illustrative UI 5500 where the user views results after entering “Sample Minimum Price.” FIG. 56 shows an illustrative UI 5600 where the user views results after entering. FIG. 57 shows an illustrative UI 5700 where the user views results after entering airports and updates minimum price. FIG. 58 shows an illustrative UI 5800 where the user views results of search.

### Conclusion

Although embodiments have been described in language specific to structural features and/or methodological acts, it is to be understood that the disclosure is not necessarily limited to the specific features or acts described. Rather, the specific features and acts are disclosed herein as illustrative forms of implementing the embodiments. Any portion of one embodiment may be used in combination with any portion of a second embodiment.

What is claimed is:

1. A system comprising:
one or more processors;
memory; and
instructions stored on the memory that, when executed by the one or more processors, configure the one or more processors to perform operations comprising:
receiving a location of an aircraft and a window of time of availability;
based at least in part on the location and window, determining one or more possible flights;
selecting a subset of the one or more possible flights; and
posting the subset to a database, a flight posting engine, or a combination thereof.

2. The system of claim 1, the instructions further comprising removing a second subset of the posted subset from the database based at least in part on a purchase of one or more of the posted subset, or a combination thereof.

3. The system of claim 1, wherein the determining one or more possible flights comprises:
determining a geographical radius based at least in part on the location, one or more characteristics of the aircraft, and the window; and
identifying an airport within the geographical radius.
